(19) United States
(12) Patent Application Publication
(10) Pub. No.: US 2026/0094379 A1
(43) Pub. Date: Apr. 2, 2026

(54) SYSTEMS AND METHODS OF PRODUCTION WORKFLOW FOR SCENE CREATION

(71) Applicant: Apple Inc., Cupertino, CA (US)

(72) Inventor: David H. HUANG, San Mateo, CA (US)

(21) Appl. No.: 19/330,648

(22) Filed: Sep. 16, 2025

Related U.S. Application Data
(60) Provisional application No. 63/700,402, filed on Sep. 27, 2024.

(51) Int. Cl. G06T 19/00

(52) U.S. Cl. CPC G06T 19/00

(57) ABSTRACT

Some examples of the disclosure are directed to systems and methods for presenting a virtual three-dimensional environment at an electronic device. Some examples of the disclosure are directed to presenting a virtual three-dimensional environment in accordance with an environmental template. Some examples of the disclosure are directed to a virtual stage, a virtual preview into the virtual three-dimensional environment, a virtual viewbox, a virtual model, and an immersive presentation of the virtual three-dimensional environment.

### CROSS-REFERENCE TO RELATED APPLICATIONS

This application claims the benefit of U.S. Provisional Application No. 63/700,402, filed Sep. 27, 2024, the content of which is incorporated herein by reference in its entirety for all purposes.

### FIELD OF THE DISCLOSURE

This relates generally to systems and methods of presenting virtual three-dimensional environments and, more particularly, to presenting of virtual scenes in accordance with templates.

### BACKGROUND OF THE DISCLOSURE

Some computer graphical environments provide two-dimensional and/or three-dimensional environments where at least some objects presented for a user's viewing are virtual and generated by a computer. In some examples, virtual three-dimensional environments can be based on one or more images of the physical environment of the computer. In some examples, virtual three-dimensional environments do not include images of the physical environment of the computer.

### SUMMARY OF THE DISCLOSURE

This relates generally to systems and methods of presenting virtual three-dimensional environments and, more particularly, to presenting the virtual three-dimensional environment in accordance with an environmental template. In some examples, the template includes one or more of a virtual stage, a virtual model, a virtual preview and/or viewing portal, a virtual viewbox, and/or an immersive view of the virtual three-dimensional environment. In some examples, data and information used to display the virtual three-dimensional environment at an electronic device such as a headset is received and/or streamed from a computer system. In some examples, an electronic device exports virtual content from the virtual three-dimensional environment. In some examples, an electronic device changes an active environmental template. In some examples, an electronic device facilitates viewing and interaction with a virtual three-dimensional environment for a media production workflow.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting a three-dimensional environment according to some examples of the disclosure.

FIGS. 2A-2B illustrate block diagrams of example architectures for electronic devices according to some examples of the disclosure.

FIG. 3 illustrates an example of an electronic device presenting a virtual three-dimensional environmental template including a virtual stage according to some examples of the disclosure.

FIG. 4 illustrates display of an environmental template including a virtual model according to some examples of the disclosure.

FIG. 5 illustrates display of a virtual environment with a level of immersion greater than a threshold level of immersion according to some examples of the disclosure.

FIG. 6 illustrates display of review of animations according to some examples of the disclosure.

FIG. 7 illustrates an example of electronic devices presenting a virtual three-dimensional environmental template including a virtual model and an environmental preview according to some examples of the disclosure.

FIG. 8 illustrates an example of an electronic device presenting a virtual three-dimensional environmental template including a viewbox according to some examples of the disclosure.

FIG. 9 is a flow chart of a method of presenting a virtual three-dimensional environment in accordance with a template according to some examples of the disclosure.

FIG. 10 is a flow chart of a method of streaming information from a computer system to an electronic device to cause the electronic device to present a virtual three-dimensional environment in accordance with a template according to some examples of the disclosure.

### DETAILED DESCRIPTION

This relates generally to systems and methods of presenting virtual three-dimensional environments and, more particularly, to presenting the virtual three-dimensional environment in accordance with an environmental template. In some examples, the template includes one or more of a virtual stage, a virtual model, a virtual preview and/or viewing portal, a virtual viewbox, and/or an immersive view of the virtual three-dimensional environment. In some examples, data and information used to display the virtual three-dimensional environment at an electronic device such as a headset is received and/or streamed from a computer system. In some examples, an electronic device exports virtual content from the virtual three-dimensional environment. In some examples, an electronic device changes an active environmental template. In some examples, an electronic device facilitates viewing and interaction with a virtual three-dimensional environment for a media production workflow.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed in the three-dimensional environment in a world-locked orientation, a body-locked orientation, a tilt-locked orientation, or a head-locked orientation, as described below. As used herein, an object that is displayed in a body-locked orientation in a three-dimensional environment has a distance and orientation offset relative to a portion of the user's body (e.g., the user's torso). Alternatively, in some examples, a body-locked object has a fixed distance from the user without the orientation of the content being referenced to any portion of the user's body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user's head. In some examples, a head-locked object moves within the three-dimensional environment as the user's head moves (as a viewpoint of the user changes).

As used herein, an object that is displayed in a world-locked orientation in a three-dimensional environment does not have a distance or orientation offset relative to the user.

As used herein, an object that is displayed in a tilt-locked orientation in a three-dimensional environment (referred to herein as a tilt-locked object) has a distance offset relative to the user, such as a portion of the user's body (e.g., the user's torso) or the user's head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user's head). For example, the tilt-locked object is moved in the three-dimensional environment based on movement of the user's head within a spherical space surrounding (e.g., centered at) the user's head. Accordingly, if the user tilts their head (e.g., upward or downward in the pitch direction) relative to gravity, the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise) relative to gravity, the tilt-locked object is not repositioned within the three-dimensional environment.

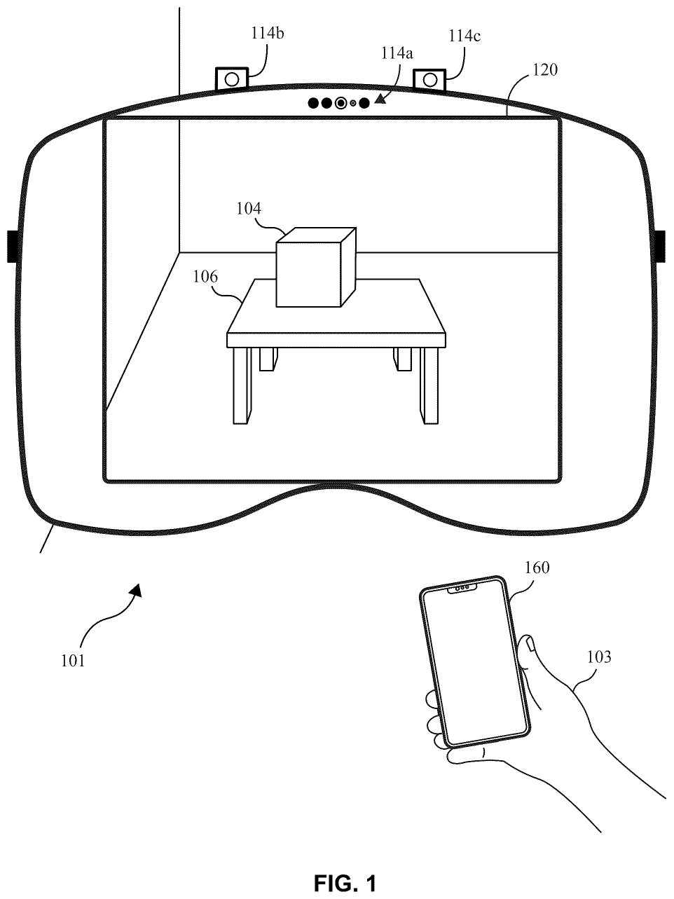

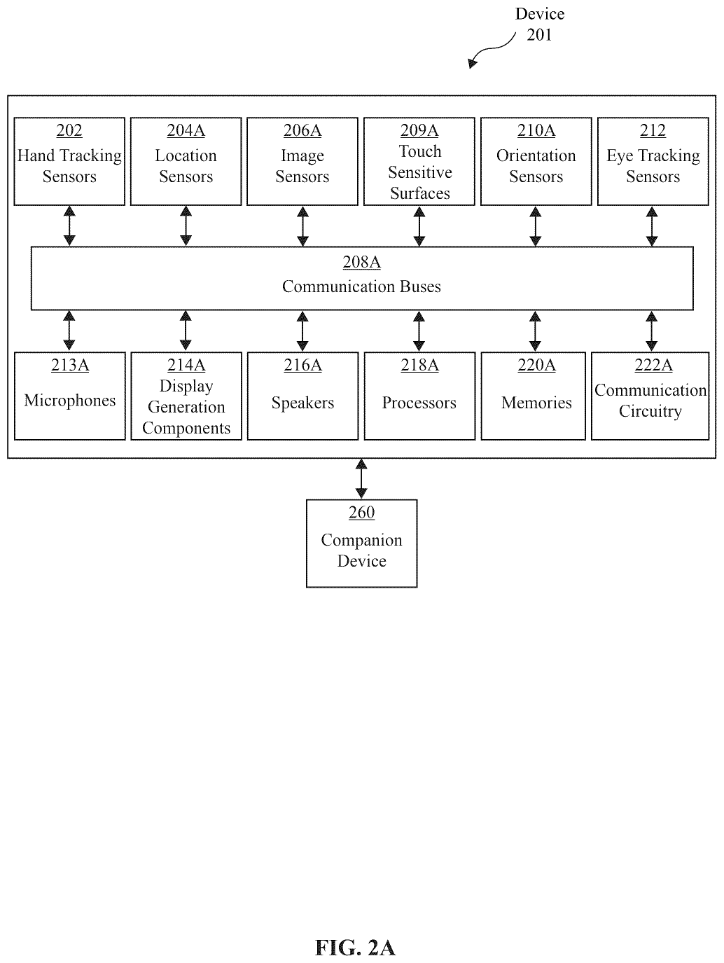

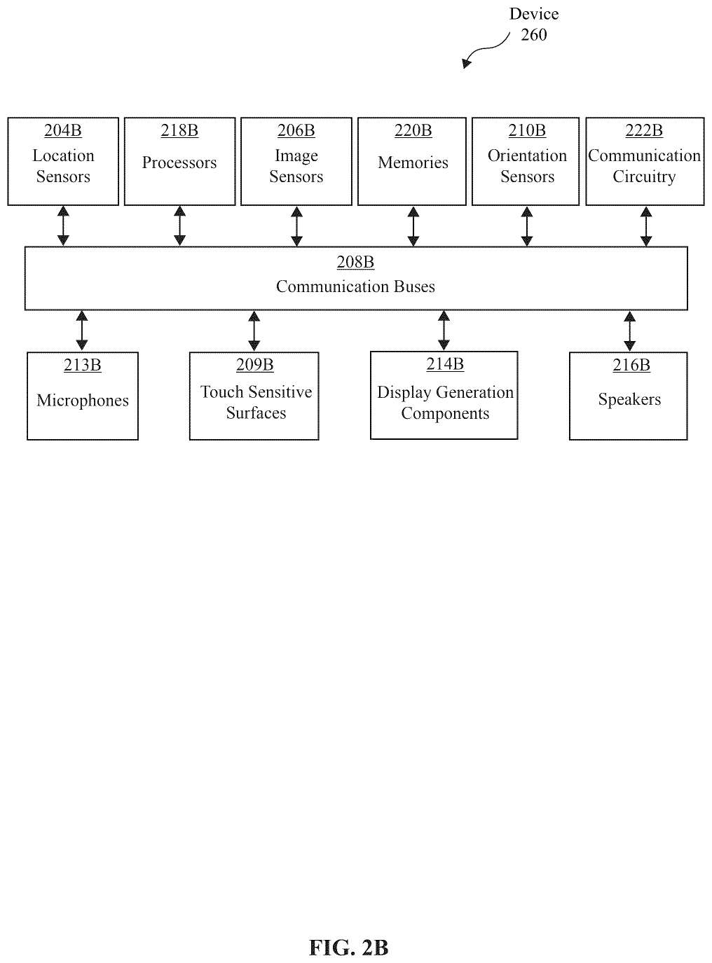

FIG. 1 illustrates an electronic device 101 presenting three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras as described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. A viewpoint of a user determines what content is visible in the field of view, a viewpoint generally specifies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user's brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user's field of view (e.g., the field of view of the user's eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment.

For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not).

Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user's hands, and/or motions of one or more portions of the user's hands with respect to the three-dimensional environment, relative to the one or more display generation components 214A, and/or relative to another defined coordinate system. The one or more eye tracking sensors 212 are configured to track the position and movement of a user's gaze (e.g., a user's attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Some examples of the disclosure are directed to electronic device(s) and/or computer system(s) configured to communicate information to view and/or interact with virtual scenes. A virtual scene can include virtual content and/or other information rendered at a particular device for viewing and/or interaction, such as a virtual campground, a virtual office, a virtual meadow, a virtual town, and/or the like. In some examples, the virtual scene can include user and/or computer-generated assets such as a virtual floor, sky, grouping of object(s), and/or metadata relating to such assets.

In some examples, the virtual scene can be displayed at a device. While displaying the virtual scene, a user of the device can view, edit, and/or share comments about contents of the virtual scene. In some examples, the displaying device presents the virtual scene in an extended reality (XR), virtual reality (VR), and/or mixed reality (XR) environment that includes a portion of the virtual scene. In some examples, the virtual scene is displayed using an environmental template as described further herein. In some examples, the environmental template is included in a user interface for creating content. For example, the user interface can be for an application that facilitates editing of universal scene description (USD) files, and virtual assets included in the USD files. The user interface and/or the virtual elements included in the environmental template can provide a user of the device to inspect the virtual scene, comment about the virtual scene, and/or rapidly collaborate with other users of other devices during inspection of the virtual scene.

In some examples, the displaying device can display virtual content within the elements included in, and/or can itself be included in an environmental template for displaying a virtual environment. The virtual content can be displayed with a first level of detail, including a resolution, appearance, simulated lighting, and/or some combination thereof of virtual assets displayed within the stage. The examples herein enumerate several operations relating to the manner by which the virtual scene is presented using an environmental template and by which users of device can interact with a virtual scene while displaying a content creating user interface in accordance with the environmental template.

The advent of digital display technology has allowed professionals and hobbyists alike to create and share virtual content for consumers across the globe. For example, directors, cinematographers, visual effect artists, architects, designers, and software engineers can use digital tools to create, share, and interact with virtual content such as virtual backdrops, virtual scenes, virtual objects, and/or virtual user interfaces. Some devices are configured to present the virtual content within virtual reality (VR), extended reality (XR), and/or mixed reality (MR) environments. By displaying the virtual content within such environments, the devices can enable more intuitive, efficient, and novel ways to view and interact with the virtual content. It can be appreciated, however, current platforms used to present virtual content enforce limited or outright inflexible methods of presenting the virtual content. Thus, systems and methods for presenting virtual content in a variety of spatial and interactive formats can be desired, especially in the context of creating different types of content during a process of a media production workflow.

Some examples of the present disclosure are directed to the different ways that virtual content can be presented within a content creation user interface. The content creation user interface can include options to select a type of content creation project such as a real-time experience, an immersive video, a spatial video, a three-dimensional film, and/or a conventional film project. In some examples, the devices can present the virtual content and/or scene in accordance with an environmental template. The environmental template, in some examples, can dictate how the virtual content is displayed and/or what interactions are available to users of the devices when initiating presentation of the virtual content and/or scene. In some examples, one or more of the devices can communicate using a multi-user communication session to concurrently and/or collaboratively interact with the virtual content. In some examples, a host device such as a desktop computer and/or a server can stream data and metadata to the one or more devices, offloading at least some of the processing required to render and/or display the virtual content. In this way, the examples of the disclosure contemplated herein offer novel approaches for rapidly creating, inspecting, and reviewing content, such as when creating three-dimensional computer graphics data.

In some examples, a device such as a headset device can display a virtual scene in accordance with a template environmental format. In some examples, displaying the virtual scene using an environmental format includes displaying a virtual stage and/or a virtual background. In some examples, displaying the virtual scene using an environmental format includes displaying a model of the virtual scene. In some examples, displaying the virtual scene using an environmental format includes displaying a preview virtual object such as a viewing portal. In some examples, displaying the virtual scene using an environmental format includes displaying the virtual scene as an environment with a level of immersion greater than a threshold level of immersion. In some examples, displaying the virtual scene using an environmental format includes displaying a viewbox corresponding to a region within the virtual scene.

By presenting a same virtual scene in accordance with various environmental templates, the presenting device can ensure that virtual content is presented in a manner conducive to inspection, editing, and/or exporting of assets, such as presenting an appropriate scale and/or view of the virtual scene. For example, displaying a virtual model of a virtual three-dimensional environment can place visual emphasis on the spatial arrangement of a plurality of virtual objects, which can be relatively less emphasized when displaying a virtual stage within which a virtual road and/or one or more of the virtual objects are displayed. Additionally or alternatively, in some examples, displaying a viewing portal can present a two-dimensional shape which can be suited for previewing how a virtual three-dimensional environment will appear when used to as a backdrop to generate two-dimensional and/or videos.

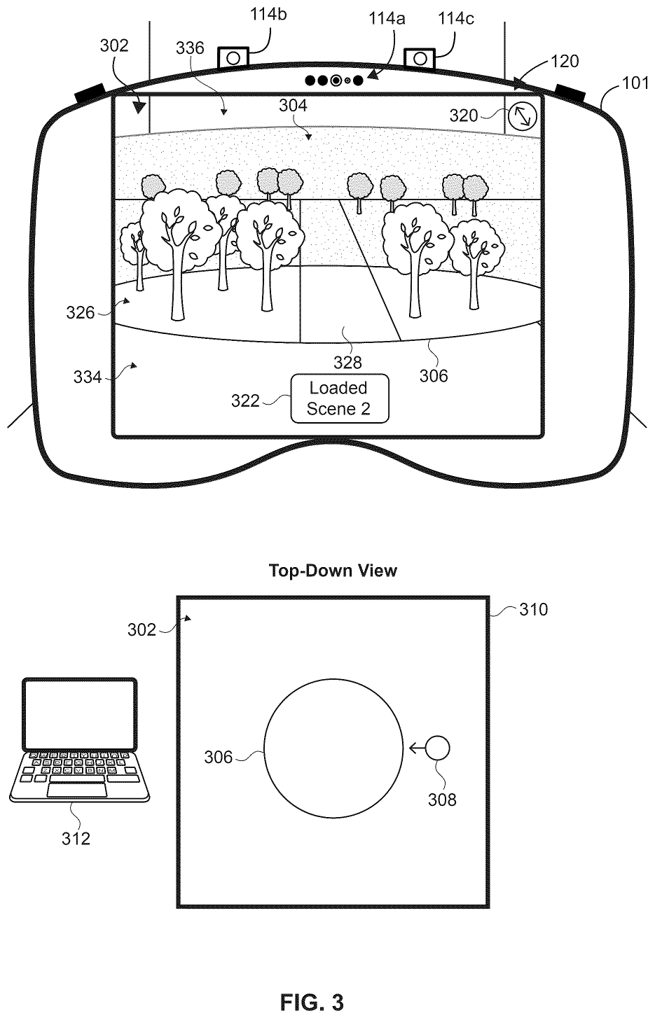

It can be appreciated that the particular order of inputs, determinations, presentation of information, and other operations described with respect to FIGS. 3-8 are merely exemplary, and that examples in which the order of execution of such operations can be different from as expressly described are also contemplated without departing from the scope of the present disclosure.

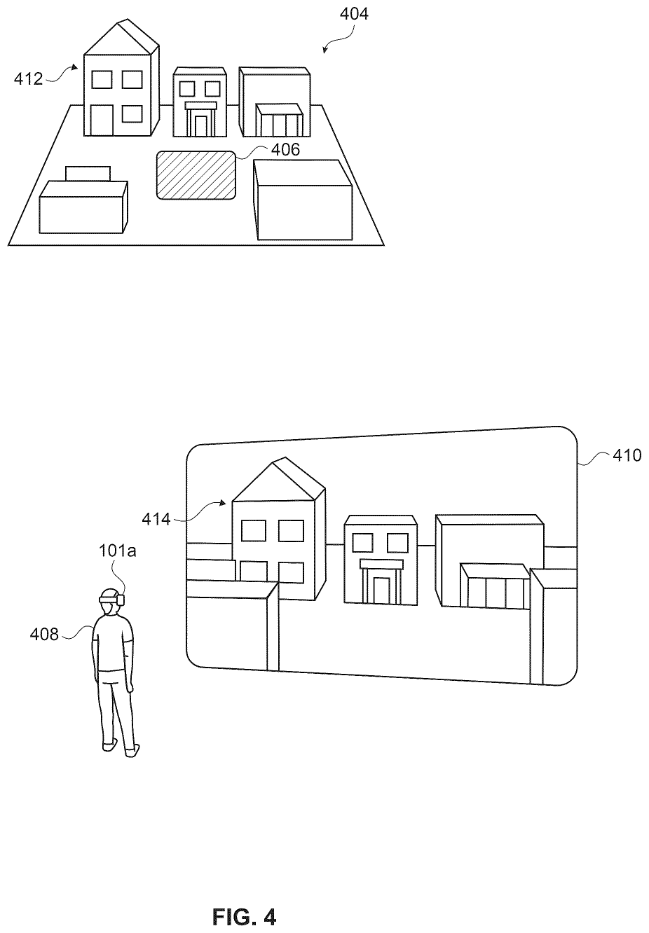

FIG. 3 illustrates an example of an electronic device presenting a virtual three-dimensional environmental template including a virtual stage according to some examples of the disclosure. In some examples, the electronic device 101 is of the same architecture as electronic device 101 described above with reference to FIG. 1 and/or electronic device 201 described above with reference to FIG. 2. In some examples, the virtual scene displayed as shown in FIG. 3 is displayed in response to receiving an indication of a virtual stage environmental format. In some examples, the virtual stage defines a region where created virtual content can be displayed and/or interacted with. Some examples of the disclosure described with reference to FIG. 3 apply to additional or alternative examples, such as those described with reference to FIGS. 4-8 (e.g., description of attention, virtual environments in general, avatars, annotations and/or the like). Some examples of disclosure described with reference to FIG. 3, such as those described with reference to stage 306 further herein, can be directed toward displaying a virtual scene in accordance with a virtual stage template when an indication of a virtual stage environmental format and/or environmental template is received, such as a request received at electronic device 101 from computer system 312.

In some examples, electronic device 101 can be a first electronic device that is used by a user 308 to display user interfaces for viewing and interacting with virtual content and/or accessing and participating in a communication session. For example, electronic device 101 can be a mobile device (e.g., a tablet, a smartphone, a media player, or a wearable device), or a computer or other electronic device. In some examples, the display generation component is a display integrated with the electronic device (optionally a touch screen display), external display such as a monitor, projector, television, and/or a hardware component (optionally integrated or external) for projecting a user interface or causing a user interface to be visible to one or more users. In some examples, the one or more input devices include an electronic device or component capable of receiving a user input (e.g., capturing a user input, detecting a user input) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device and/or a motion sensor (e.g., a hand tracking device, a hand motion sensor). In some examples, the electronic device is in communication with a hand tracking device (e.g., one or more cameras, depth sensors, proximity sensors, touch sensors (e.g., a touch screen, or trackpad)). In some examples, the hand tracking device is a wearable device, such as a smart glove. In some examples, the hand tracking device is a handheld input device, such as a remote control or stylus.

In some examples, computer system 312 transmits and/or receives (e.g., streams) information such as data. In some examples, computer system 312 includes some or all of the circuitry of electronic device 101 and/or electronic device 201 (e.g., described with reference to FIGS. 1 and 2A-2B). In some examples, electronic device 101 and computer system 312 are different types of devices. For example, computer system 312 can be a desktop or laptop computer and electronic device 101 can be a wearable device such as a headset. In some examples, computer system 312 streams the data using one or more data formats, such as JavaScript Object Notation (JSON), extensible markup language (XML), and/or Graphics Library Transmission Format (GLTF). In some examples, computer system and/or electronic device 101 use the streamed data to render and/or otherwise represent scene graphs, object models, animation data, and other graphics-related information.

In some examples, electronic device 101 with computer system 312 communicates using one or more protocols, such as a UDP (User Datagram Protocol) and/or a TCP/IP (Transmission Control Protocol/Internet Protocol) protocol to transmit data packets to and/or receive data packets from computer system 312. In some examples, computer system 312 can host and/or manage XR applications used by electronic device 101 to render displayed virtual content. For example, computer system can implement a client-server architecture where a central computing unit (e.g., computer system 312) manages a state of a virtual environment and sends updates to connected clients (e.g., electronic device 101 and additional or alternative devices).

In some examples, the three-dimensional environment is generated, displayed, or otherwise caused to be viewable by the device (e.g., a computer-generated reality (CGR) environment such as a virtual reality (VR) environment, a mixed reality (MR) environment, and/or an augmented reality (AR) environment). For example, three-dimensional environment 302 can include the physical environment and/or virtual environment of user 308 and electronic device 101.

In FIG. 3, three-dimensional environment 302 includes a virtual three-dimensional environment (e.g., at times referred to herein as a virtual scene) that includes a plurality of virtual objects and/or textures, the virtual scene displayed via display 120 of electronic device 101. In some examples, electronic device 101 displays the virtual scene in a manner that entirely replaces a view of the physical environment, as though the user were physically within a physical equivalent of the virtual scene. In some examples, display of the virtual scene replacing the view of the user's physical environment can correspond to displaying the virtual scene with a level of immersion greater than a threshold level of immersion, the level(s) of immersion described further herein. In some examples, in response to detecting a change in the user's viewpoint (e.g., changes to the user's position and/or orientation) in the physical environment, the electronic device can change the perspective view of the virtual scene, as though the user were changing positions within the virtual scene. In FIG. 3, three-dimensional environment 302 is illustrated from the perspective of the electronic device 101, and additionally from an overhead perspective in a glyph 310 below the perspective of electronic device 101.

In some examples, the virtual scene is an immersive three-dimensional environment. For example, a user of electronic device 101 is able to physically move throughout their physical environment (including areas of the physical environment illustrated beyond the extremities of a housing of electronic device 101 in FIG. 3), and device 101 optionally updates a simulated perspective of a virtual sky, virtual floor, objects in response to detecting changes of the user's viewpoint (e.g., the user's position and/or orientation relative to their physical environment), similar to a physical perspective of a physical sky, physical floor, and/or one or more physical objects as the user moves relative to their physical environment. In some examples, the virtual scene included in three-dimensional environment 302 optionally includes a simulated texture overlaying a physical representation of the floor of the user's physical environment, and/or a virtual floor having a simulated spatial profile (e.g., topography) that is different from that of the user's physical environment. Further, the virtual scene can include a simulated atmosphere, such as a virtual sky (e.g., simulating the lower atmosphere at dawn, daylight hours, dusk, nighttime hours, and the like). It is understood that the virtual scene can be any suitable computer-generated environment without departing from the scope of the disclosure.

In FIG. 3, the user's physical environment is illustrated beyond extremities of a housing of electronic device 101. It is understood that description of the three-dimensional environments, virtual environments, and/or the physical environments described with reference to FIG. 3 can at least in part apply to additional or alternative example operations and techniques described herein referencing three-dimensional environments, virtual environments, and/or the physical environments as described with reference to FIGS. 4-8.

In some examples, the virtual scene is displayed as though occupying one or more regions of the user's physical environment. The physical environment—illustrated in FIG. 3 outside of a housing of electronic device 101—can include a physical room that the user 308 occupies. In some examples, the virtual scene can be displayed, by display 120, at least partially replacing a view of a representation of the user's physical environment, thus “consuming” a view of the physical environment. For example, electronic device 101 can include one or more outward facing cameras that obtain images of the user's physical environment (e.g., image sensors 114a-b), and the images can be displayed via display 120 as if the user were able to view the physical environment directly, without the assistance of electronic device 101. At least a portion or all of such a view of the physical environment can be displayed at corresponding positions of display 120 and with a level of opacity less than a threshold level (e.g., 0, 1, 5, 10, 15, 20, 25, 30, 35, 40, 45, or 50% opacity), and the virtual scene can be displayed at those corresponding positions with a level of opacity greater than a threshold level of opacity (e.g., 0, 1, 5, 15, 25, 40, 50, 60, 65, 75, 90, or 100% opacity). Additionally or alternatively, in some examples, portions of the physical environment can be visible through a transparent portion of the display without the display actively displaying those portions of the physical environment.

In some examples, the physical environment of user 308 can include one or more physical objects in the user's environment, physical individuals in the user's environment, physical walls, a physical floor, and the like. In some examples, the electronic device 101 can present representations of the user's physical environment. For example, the virtual scene included in three-dimensional environment 302 in FIG. 3 can be displayed with an at least partial degree of translucency, overlaying a representation and/or view of the user's physical environment (e.g., images collected by sensors 114a-c of the user's physical environment) presented via display 120. In some examples, presenting the three-dimensional environment 302 includes displaying virtual content and/or presenting a view of the user's physical environment (e.g., via passive optical passthrough including a lens and/or a partially or entirely transparent sheet of material such as glass). In some examples, a representation of the user's physical environment includes one or more images of the user's physical environment. In some examples, the electronic device 101 displays a real-time, or nearly real-time stream of images (e.g., video) of one or more portions of the physical environment corresponding to a “representation” of the user's physical environment.

As described previously, the virtual scene can include one or more virtual objects in some examples of the disclosure. The virtual objects can include digital assets modeling physical objects, virtual placeholder objects (e.g., polygons, prisms, and/or simulated two or three-dimensional shapes), virtual objects including user interfaces for applications (e.g., stored in memory by electronic device 101), and/or other virtual objects that can be displayed within a VR, XR, and/or MR environment. As an example, three-dimensional environment 302 includes virtual road 328, a foreground 326 within stage 306, a virtual background corresponding to background 304 including virtual trees, which optionally are virtual assets displayed within the virtual scene at a simulated position similar to a physical position and orientation of a physical objects relative to a viewpoint of user 308. It is understood that a greater number, a fewer number, and/or alternative objects can be displayed without departing from the scope of the disclosure.

In some examples, the electronic device 101 concurrently displays a virtual border and/or boundary concurrently with the virtual scene. For example, a boundary of virtual stage 306 is displayed in FIG. 3, which includes a curved line illustrating a round border. In some examples, the boundary is displayed with visual properties, such as with a color, brightness, saturation, opacity, hue, simulated lighting and/or glowing effect mimicking the visual appearance of a light source illuminating the virtual scene, and/or a width to distinguish the boundary from three-dimensional environment 302. In some examples, the virtual border (and therefore stage 306) is optionally triangular, pentagonal, circular, elliptical, and/or any other suitable polygonal shape and/or set of curves. In some examples, the virtual border is volumetric, occupying one or more portions of the virtual floor and/or one or more portions of the virtual scene above the virtual floor. As an example, the boundary is optionally a sphere, cube, rectangular prism, and/or another suitable volumetric shape, optionally including a visually distinguished one or more edges. Displaying a virtual border reduces the likelihood that the user moves erroneously relative to the three-dimensional environment in a manner that would cause electronic device 101 to cease display of virtual content that is within and/or corresponds to the virtual border, thereby reducing processing required to perform operations based on such erroneous movement.

In some examples, electronic device 101 displays virtual content within stage 306 with a first rendering technique. For example, electronic device 101 can use the first technique to display first content in foreground 326 with the one or more first levels of detail. It is understood that the specific rendering technique is not limited, but can include one or more of multi-rendering of targeted virtual content, deferred and forward rendering, screen space effects such as ambient occlusion, subsurface scattering, and/or distortion and refraction, stereoscopic rendering, foveated rendering, asynchronous time warping, reprojection, late latching, deferred shading, ray tracing, ray casting, radiosity analysis, path tracing, neural rendering, and/or some combination thereof. It is further understood that in general, virtual content can be rendered to be relatively high-resolution portions of images, video, and/or animations presented by electronic device 101 for interaction by a user of electronic device 101. By displaying the virtual content using the first rendering technique, a user of electronic device 101 can inspect a high-fidelity portion of the virtual scene, which can reduce time and efforts to closely inspect virtual assets when creating virtual content using the virtual scene (e.g., images, videos, animations, immersive virtual experiences, and/or using the virtual scene as a backdrop for traditional media such as television and/or film).

In some examples, electronic device 101 displays virtual content outside of stage 306 with a second rendering technique, different from the first rendering technique. For example, electronic device 101 can display background 304 with the second rendering technique, which can include displaying a lower resolution, lower amount of detail in shading and/or textures, and/or some combination thereof. In some examples, implementing display of virtual content with the second rendering technique includes displaying the virtual content outside of stage 306 with a second level of detail, different from the first level of detail. It is understood that the second rendering technique can include one or more characteristics similar to, or the same as described with reference to the first rendering technique. In some examples, the second rendering technique can differ from the first technique, by way of omitting one or more of the techniques, setting different thresholds for algorithms used to determine the manner of display of virtual content, by including certain one or more techniques not included in the first rendering technique, and/or some combination thereof. Moreover, the mixed-rendering approach reduces the computing demands of electronic device 101 and/or a computer system in communication with electronic device 101 by potentially using more computationally intensive technique(s) for virtual content that is closer to the viewpoint of the user and/or less computationally intensive technique(s) that are further away from the viewpoint of the user.

In general, it is understood that by displaying virtual content with the second technique, electronic device 101 can reduce the computation required to display the virtual content as compared to displaying the same virtual content with the first rendering technique. As an example, electronic device 101 can display a virtual cloud with a resolution that is lower than if virtual cloud were displayed in stage 306. Additionally or alternatively, the cloud can move with a simulated parallax effect in response to detecting movement of a viewpoint of electronic device 101. In some examples, the virtual content outside of stage 306 corresponds to a midground and/or background of the virtual scene. In some examples, electronic device 101 can render other portions of the virtual scene concurrently with stage 306 and/or background 304, such as by using a third rendering technique, different from the first and/or second technique. By simplifying computational complexity that may be involved with display of the virtual content by leveraging a plurality of rendering techniques, electronic device 101 and/or a computer system that streams the data used to display the virtual content at electronic device 101 reduces the amount of data that can be sent and/or reduces the processing required at electronic device 101 and/or at the computer system.

In some examples, electronic device 101 can detect input toward virtual content included in the three-dimensional environment 302 (e.g., gaze, a voice command, an air gesture (e.g., an air pinch including one or more contacts of a plurality of fingers of the user, an air pointing of one or more fingers, and air clenching of one or more fingers), contact with a trackpad, and/or selection with a stylus). In response to receiving the input directed to a virtual object, the electronic device 101 can initiate a scaling and/or moving of virtual objects in a first dimension, and by a first magnitude corresponding to a direction and/or magnitude of the user input. Additionally or alternatively, the electronic device 101 can initiate a scaling of a virtual object in a second, different direction in response to input directed to the virtual object.

In some examples, while a position and/or orientation of user 308 corresponds to a region of the three-dimensional environment 302 corresponding to the virtual scene, the electronic device 101 displays the virtual scene with a first visual appearance. For example, the electronic device 101 displays the virtual scene with a first level of immersion (e.g., full immersion, in which the virtual scene replaces any representation of the user's physical environment). In some examples, the level of immersion includes or corresponds to the degree to which virtual content consumes a viewport of electronic device 101. In some examples, the level of immersion additionally or alternatively includes visual characteristics of the virtual scene, such as an opacity, brightness, saturation, level of resolution, and/or some combination thereof. For example, a threshold level of immersion can define the percentage value and/or locations within three-dimensional environment 302 consumed by the virtual three-dimensional environment, such as a 5%, 15%, 25%, 35%, 50%, 75%, or 90% level of immersion. For example, electronic device 101 can display virtual content replacing presentation of a representation of the physical environment, and as the level of immersion increases, the percentage of the viewport consumed by the virtual three-dimensional environment can increase. Accordingly, when displaying the virtual three-dimensional environment at a 100% level of immersion, user 308 optionally may not see physical objects that may be in their physical environment (temporarily). Thus, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or were previously obscured.

In some examples, before initiating display of the virtual scene, the electronic device 101 displays the boundary of virtual stage 306 overlaying a representation (e.g., image(s) and/or video) of the user's physical environment, prompting user 308 to remove physical objects from the region of three-dimensional environment 302 bounded by the boundary. In FIG. 3, the electronic device 101 displays the virtual sky, the virtual floor, and the virtual objects described previously at a relatively high level of opacity (e.g., 100% opacity).

In some examples, electronic device 101 displays one or more representations of individuals other than user 308 via display 120. For example, electronic device 101 can display virtual avatars and/or additional or alternative media such as virtual windows including images of users corresponding to the avatars. Thus, electronic device 101 can display representations of other individuals that are virtually or physically included in the user's three-dimensional environment 302. As an example, the representations can be expressive avatars, such as anthropomorphic avatars, having one or more body parts that can move relative to each other.

The body parts optionally include a head, hand(s), arm(s), shoulder(s), a neck, leg(s), finger(s), toe(s), facial features, and the like. In some examples, the representations can correspond to individuals that share the user's physical environment, such as individuals that are in the user's physical room. In some examples, the representations are presented via a passive optical passthrough (e.g., a lens, a transparent material, and/or directly visible to the eyes of the user), and correspond to a view of their respective, corresponding physical users. The representation can include a plurality of body parts, as an example of a fully expressive avatar or a representation of a physical individual sharing the physical environment of user 308. In some examples, a representation includes a partially expressive avatar or representation of a user of an electronic device that is not physically sharing the physical environment of user 308. It is understood that such representations are merely exemplary, and that additional or alternative representations of users of corresponding electronic devices can be included in three-dimensional environment 302.

In some examples, the representations of users can correspond to individuals that are not in the user's physical environment but are represented using spatial information. In some examples, electronic device 101 uses the spatial information to map portions of the physical environment of user 308 to portions of the virtual scene, and/or to map portions of the physical environments of the individuals corresponding to the representations of users to the portions of the virtual scene. As an example, a communication session between electronic device 101, a first electronic device used by a first user represented by a first representation, and a second electronic device used by a second user represented by a second representation can be ongoing to facilitate the mapping between physical environments of respective users of respective electronic devices. In some examples, the communication session includes communication of information corresponding to real-time, or nearly real-time communication of sounds detected by the electronic devices (e.g., speech, sounds made by users, and/or ambient sounds). In some examples, the communication session includes communication of information corresponding to real-time, or nearly real-time movement and/or requests for movement of representations (e.g., avatars) corresponding to users participating in the communication session.

For example, the first electronic device can detect movement of the first user corresponding to the first representation in the physical environment of the user (e.g., different from the physical environment of user 308) and can communicate information indicative of that movement with the electronic devices participating in the communication session, including electronic device 101. Prior to detecting the movement, the first electronic device can display the virtual scene relative to a viewpoint of the first electronic device (e.g., a position and/or orientation relative to the virtual scene, similar to a physical position and/or orientation of the user relative to a physical equivalent of the virtual scene). In response to detecting the movement (e.g., obtaining information indicative of the movement from the other electronic device), the first electronic device can update the viewpoint of the user of the first electronic device in accordance with the physical movement (e.g., in a direction, and/or by a magnitude of movement) to an updated viewpoint, as though the user of the first electronic device were physically moving through a physical equivalent of the virtual scene. It can be appreciated that requests for such movement can be directed to an input device (e.g., a virtual joystick, a trackpad, a physical joystick, a virtual button, a physical button, and/or another suitable control) in addition to or in the alternative to detecting physical movement of the user. Electronic device 101 can receive such information, and in response, can move the representation relative to the virtual scene by a magnitude and/or direction of movement that mimics the physical movement of the user of the first electronic device relative to the physical environment of the user of the first electronic device. It is understood that other electronic devices—such as an electronic device corresponding to the second representation and/or electronic device 101—can also detect similar inputs described with reference to the first electronic device, and cause movement of their corresponding representation within the virtual scene.

It is also understood that movement and/or placement of representations of users participating in the communication session can be defined relative to a shared coordinate system, rather than strictly relative to virtual dimensions of the virtual scene. For example, the electronic device 101 can present a view of the physical environment of user 308 not including a virtual scene and can display representations of users at positions within the view of the physical environment and/or movement of the representations of the users within the view of the physical environment. It is understood that the examples described with respect to FIGS. 3-8 can occur during a communication session (described herein), and that information communicating positions, orientations, audio, and/or other aspects of physical users and/or information provided by physical users can be exchanged via the communication session to devices participating in the communication session. It is understood that dependent upon context, the operations described with reference to virtual content being displayed relative to the virtual scene can be displayed relative to a representation of the user's physical environment, such as visual indications of attention of the user 308.

In some examples, electronic device 101 displays one or more visual indications indicating user attention within three-dimensional environment 302. For example, electronic device 101 detects a virtual position of a target of the user's attention (e.g., gaze), and displays a visual indication at the virtual position, thus presenting a visual indication of the portion of three-dimensional environment 302 that the user's attention is targeting. In some examples, the target of the user's attention is indicated using one or more portions of the user's body other than the eyes. For example, although not shown in FIG. 3, electronic device 101 can detect a spatial relationship between a point of contact between one or more fingers included in hand of the user 308 (e.g., forming an air pinching gesture or an air pointing gesture) and electronic device 101. The spatial relationship can be based upon a ray cast from a portion of electronic device 101, such as a center of electronic device 101, through the portions of the user's body (e.g., through the air pinch gesture, through a fingertip arranged in an air pointing gesture), and extending toward a position within the virtual scene.

In some examples, attention is detected and/or information indicative of a target of attention is obtained by electronic device 101, and electronic device 101 displays a visual indication of the attention in response to the detection and/or obtaining. In accordance with a determination that attention of a user is directed to a portion of the virtual scene that is not visible (e.g., as though a physical user is gazing at a portion of a physical object in the physical environment of the user corresponding to a representation that the user 308 cannot see from their perspective), electronic device 101 forgoes display of a representation of attention of the representation. Additionally or alternatively, electronic device 101 can display a visual indication of attention with a modified appearance (e.g., a different spatial profile such as a simulated glow surrounding a portion of a virtual tree included in foreground 326, an arrow with a simulated depth curving behind the virtual tree, and/or with visual characteristics (e.g., opacity, blurring, saturation, and/or a simulated lighting effect)) to convey that a target of attention of the user corresponding to a representation is not currently visible to user 308. It is understood that the visual indications of attention can be displayed and are at times omitted from the figures for convenience.

In some examples, the virtual scene has a simulated depth, and the visual indication is displayed at a position in accordance with the user's attention and/or the spatial relationship between the electronic device 101 and the air gesture. As an example, electronic device 101 in FIG. 3 can display a visual indication at a position on a surface of the virtual floor included in the virtual scene due to the user's gaze, and/or the ray projected from electronic device 101 through the air pinch gesture intersecting with the position on the virtual floor.

In some examples, as described herein, electronic device 101 can display indications of attention of the other users. For example, in FIG. 3, attention (e.g., gaze) of a user corresponding to representation of another user of another electronic device is directed to the virtual floor. The electronic device of that user can detect that the floor is the target of the user's attention and can communicate information indicative of that target to electronic device 101. In response to obtaining the information, electronic device 101 can display a visual indication of attention. It is understood that in some examples, in response to detecting information that the attention of a corresponding user has changed relative to the three-dimensional environment 302 and/or the virtual scene, corresponding electronic devices can communicate information moving the attention indicative of an updated target of attention. In response to obtaining such updated information, electronic device 101 can move the visual indication of attention in accordance with the updated information to an updated position and/or orientation relative to content included in the virtual scene. In some examples, the visual indication(s) of attention are displayed overlaying representations of the physical environment of user 308 (e.g., not including a portion of the virtual scene).

In some examples, electronic device 101 selectively displays the visual indication of attention. For example, when an interaction mode relative to the virtual scene is enabled (e.g., an editing mode), electronic device 101 can display the visual indication of attention. In some examples, when the interaction mode is disabled, the electronic device forgoes display of the visual indication of attention. Similarly, while the interaction mode is enabled, electronic device 101 can display other visual indications of attention of other users, and while the interaction mode is disabled, the electronic device 101 can forgo display of the visual indications of attention of the other users. In some examples, electronic device 101 displays the visual indication(s) of attention in accordance with user preference. For example, a user setting specified by electronic device 101 can permit or prohibit sharing of visual indications of attention of user 308 with other users participating in a communication session with electronic device 101. In some examples, the visual indication of attention can be displayed in response to detecting an express request to display the visual indication (e.g., a predefined air gesture performed by the user's body, a pose of one or more portions of the user's body, a verbal request to display the visual indication, and/or selection of a virtual and/or physical control (e.g., button, slider, and/or menu options)) within three-dimensional environment 302 and/or to share the visual indication with other devices participating in the communication session with electronic device 101.

FIG. 4 illustrates display of an environmental template including a virtual model according to some examples of the disclosure. In some examples, electronic device 101a displays a model 404. In some examples, electronic device 101a displays a visual indication 406 that corresponds to a view of a portal. The portal, such as portal 410, can provide a preview of at least a portion of the virtual environment, similar to as though a user is able to peer through a physical window into a physical equivalent of the virtual environment. The scale of virtual content in model 404 can be different from the scale of virtual content when electronic device 101a displays the virtual environment immersively (e.g., the scale of building 412 in the model 404 can be greater or smaller than the scale of building 414 in the portal 410). In some examples, electronic device 101a presents a view of the physical environment (e.g., similarly to or the same as described with reference to FIG. 3) concurrently while displaying model 404 and/or portal 410. In some examples, when an environmental format corresponds to a virtual model and/or viewing portal format, electronic device 101a presents the virtual environment in accordance with one or more of the examples described at least with reference to FIG. 4.

Displaying a virtual model and/or a viewing portal can provide way for a user of an electronic device to quickly preview and/or inspect virtual content included in a virtual three-dimensional environment and/or changes to the virtual content. By displaying a virtual model, the user can quickly view portions of the virtual three-dimensional environment as a whole, such as how a collection of buildings in an Old Western set may be arranged in a virtual scene. By displaying a viewing portal, the user can quickly view a collection of detailed virtual objects, textures, and/or the like included in the virtual three-dimensional environment and/or can verify that when implemented at scale, the virtual content is presented in accordance with preferences of the user. Moreover, displaying a scaled model of the virtual three-dimensional environment can reduce computation and power consumption otherwise required to display the virtual three-dimensional environment at a scale comparable to the user.

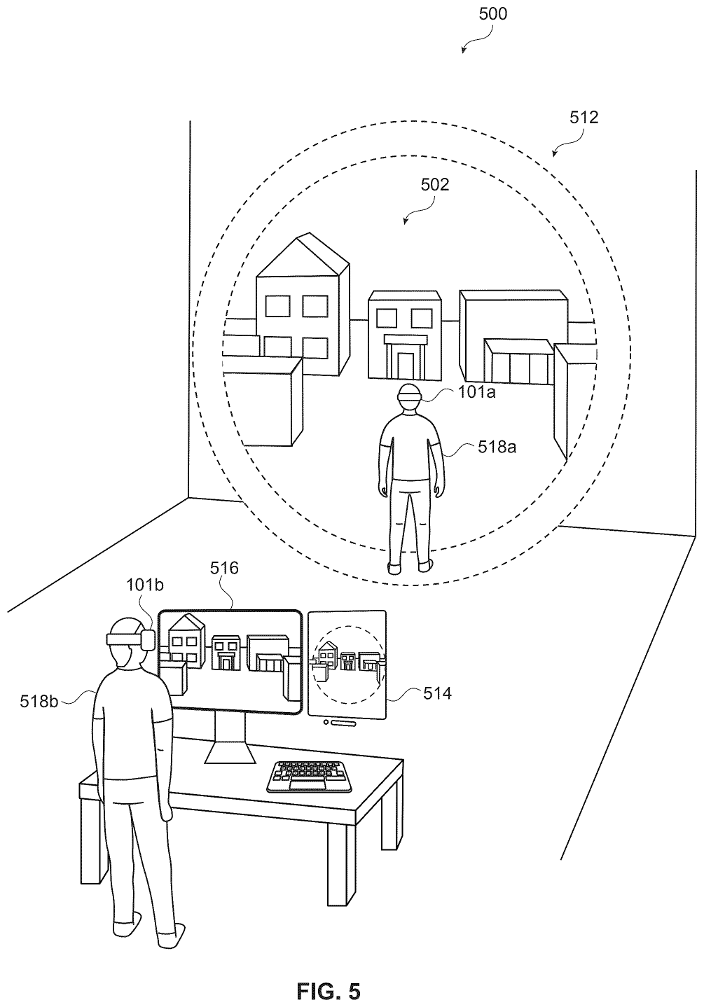

In the context of media production workflows, the viewing portal can allow users of an electronic device to quickly preview the impact of editing of virtual content included in the virtual three-dimensional environment. Additionally or alternatively, when an electronic device receives data streamed from a computer system (as described further with reference to FIG. 5), a system including the electronic device and the computer system can facilitate real-time editing and/or inspection of the virtual three-dimensional environment, without using excessive amounts of time required to render, then share, and then inspect a generated or edited virtual three-dimensional environment. Moreover, by initiating display of a virtual environment in accordance with a virtual model and/or viewing portal environmental template, the electronic device reduces user inputs to visually configure and/or emphasize portions of the virtual environment that can be useful for a particular stage of the media production workflow and/or can be useful for a corresponding type of the media content. By concurrently displaying the model 404 and portal 410, a single device (e.g., electronic device 101) may display different views of the virtual content to rapidly identify the appearance of the same virtual content displayed in different environmental formats.

In some examples, displaying the environmental template includes displaying one or both of model 404 and portal 410, such as concurrently displaying model 404 and portal 410. In some examples, electronic device 101a displays the model 404 at a first size and/or displays the portal 410 at a second size relative to three-dimensional environment 402. Model 404 can represent a miniaturized version of the virtual environment, similar to a diorama of the three-dimensional environment. In some examples, model 404 is displayed with a visual appearance in accordance with a setting specified in the template. For example, a setting can be configured to cause display of model 404 without textures. Displaying model 404 without textures can conserve processing required to inspect aspects of model 404 such as the dimension of virtual objects, the spatial arrangement of the virtual objects, the quantity of virtual objects, and/or the appearance of a simulated skyline.

In some examples, portal 410 is a two-dimensional render of the virtual environment. In some examples, the content displayed in portal 410 corresponds to a projection of visual indication 406 relative to model 404. As shown in FIG. 4, for example, portal 410 includes building 414, which corresponds to building 412 in model 404, because projecting and scaling visual indication 406 toward the content included in model 404 includes the front face of building 412.

In some examples, portal 410 and model 404 are rendered with different rendering techniques. In some examples, portal 410 and model 404 are rendered with different visual characteristics (e.g., due to the difference in rendering techniques). For example, model 404 can be displayed with a wireframe that does not include lighting effects, shading layers, textures, and/or the like. Portal 410, in contrast, can be displayed with some or all of the aforementioned visual effects, causing content displayed in portal 410 to appear closer to the appearance of a finalized render and/or to appear more realistic.

In some examples, the environmental template defines the position of model 404 and portal 410 relative to each other and/or a viewpoint of electronic device 101a. For example, model 404 can be displayed at a first position, and portal 410 can be displayed at a second, different position. In some examples, the first and/or second position are predetermined prior to initiating display of the virtual environment using the template shown in FIG. 4. In some examples, electronic device 101a detects one or more inputs requesting movement of virtual model 404 and/or portal 410, and in response, moves virtual model 404 and/or portal 410 in accordance with the one or more inputs.

In some examples, electronic device 101a is in communication with one or more other electronic devices, as described with reference to FIG. 5. In some examples, each electronic device can display a preview of the virtual three-dimensional environment at a same location relative to the physical environment as the location at which the electronic device 101a displays the preview of the virtual three-dimensional environment. For example, the preview of the virtual three-dimensional environment, which can include one or both of virtual model 404 and portal 410, can be world-locked. In some examples, if the preview of the virtual three-dimensional environment is world-locked, the position of the preview of the virtual three-dimensional environment does not change in response to detecting movement of the electronic device 101a (or one of the other electronic devices with access to the virtual three-dimensional environment). Thus, the three-dimensional environment may not move with respect to a spatial reference, other than the viewpoint of electronic device 101.

In some examples, the model 404 is body-locked to the user. For example, the model 404 can be body-locked to the user irrespective of whether electronic device 101a displays the model 404 without displaying the viewing portal previewing the virtual three-dimensional environment. In some examples, the model 404 is world-locked. For example, the model 404 is world-locked irrespective of whether the electronic device displays the model without displaying portal 410 and/or while concurrently displaying portal 410.

In some examples, the model 404 includes an indication of a virtual camera, such as a picture, graphic, icon, and/or a lighting effect displaying in the three-dimensional environment that illustrates a viewpoint relative to the three-dimensional environment from which a two-dimensional image of the virtual three-dimensional environment can be generated. For example, the model 404 includes the indication of the virtual camera facing building 412, electronic device 101a and/or a computer system in communication with electronic device 101a can generate a two-dimensional image of the building 412, similar to the appearance of a physical camera pointed toward a physical building. Additionally or alternatively, background virtual content that exists in the virtual three-dimensional environment behind building 412 can be included in the image. In some examples, the virtual camera is not associated with and/or is different from a viewpoint of user 408 relative to the three-dimensional environment. For example, the view of the virtual three-dimensional environment presented in accordance with the virtual camera can be different from the perspective of user 408 presented by electronic device 101a. In some examples, in response to detecting an input to update the position and/or orientation of the virtual camera, the electronic device 101a updates the virtual camera in model 404 and changes the displayed image to corresponds to the viewpoint indicated by the virtual camera relative to the virtual three-dimensional environment. In some examples, the electronic device 101 is able to save one or more virtual images of the virtual three-dimensional environment and/or the viewpoints of the virtual cameras. In some examples, electronic device 101a exports some or all of the virtual environment, which can include the virtual model 404, portal 410, the position and/or orientation of visual indication 406 relative to virtual model 404, the position and/or orientations of one or more virtual cameras, and/or some combination thereof. Additionally or alternatively, electronic device 101a can generate media such as the images reflecting the position of the virtual cameras, two and/or three-dimensional videos corresponding to the virtual cameras, and/or immersive video corresponding to where the virtual cameras are placed within model 404.

FIG. 5 illustrates display of a virtual environment with a level of immersion greater than a threshold level of immersion according to some examples of the disclosure (e.g., as described with reference to FIG. 3). In FIG. 5, electronic device 101a displays immersive virtual content included in a virtual environment 502 (e.g., a virtual three-dimensional environment) within an immersion region 512 while in communication with electronic device 101b and/or computer system 516. Electronic device 101a can display virtual environment 502 in accordance with an immersive environmental template, which when implemented at electronic device 101a, can cause electronic device 101a to display virtual environment 502 with a level of immersion greater than a threshold level of immersion as described further herein.

Computer system 516 can stream scenic data to electronic device 101a and/or 101b and can display the virtual environment 502 via a display concurrently while electronic device 101a displays an immersive view of virtual environment 502 (e.g., a three-dimensional environment). Additionally or alternatively, electronic device 101b can concurrently display a virtual object 514, which can include a perspective view corresponding to the viewpoint of electronic device 101a. When any of electronic device 101a, 101b, and/or computer system 516 provide inputs changing virtual content in the virtual environment 502, that change can be displayed by the other electronic device and/or computer system. Thus, electronic device 101a and 101b and computer system 516 can communicate to collaboratively develop virtual content included in virtual environment 502.

In some examples, electronic device 101a and/or 101b have one or more characteristics such as circuity, and architecture, and/or capability to perform operations described with reference to electronic device 101 shown in FIG. 1 and/or electronic device 201 shown in FIGS. 2A-2B, and/or electronic device 101a in FIG. 3. Electronic device 101a in FIG. 5 is being used by user 518a to participate in the multi-user communication session, and electronic device 101 is being used by user 518b to participate in the multi-user communication session. In some examples, the multi-user communication session has one or more characteristics similar to, or the same as those described with reference to FIG. 3.

In some examples, the immersion region 512 corresponds to what portions of the physical environment 500 are replaced with display of virtual environment 502. For example, electronic device 101a can display virtual environment 502 replacing visibility of walls, ceilings, floors, and/or physical objects. In some examples, electronic device 101a detects an input joining the multi-user communication session, and in response, initiates display of virtual environment 502 as shown in FIG. 5. Because the environmental format corresponds to an immersive type of format, electronic device 101a forgoes display of a virtual model and/or a two-dimensional portal in favor of displaying a three-dimensional version of the virtual environment 502 consuming at least a portion of a display of electronic device 101a. In some examples, immersion region 512 is a percentage of a viewport of electronic device 101a (e.g., 50%, 60%, 70%, 80%, 90%, or 100%).

In some examples, the degree to which virtual content replaces visibility of representations of aspects of physical environment 500 corresponds to a level of immersion. A level of immersion can include the percentage of display 120 that includes virtual environment 502 (and does not include a view of physical environment 500 via a transparent passthrough and/or a camera reproduction of physical environment 500). The level of immersion, for example, can include a width and/or a height of display 120 that includes contiguous virtual content. The level of immersion can additionally or alternatively include the position within the three-dimensional environment that virtual content overlays physical environment 500, such as a border delineating the start of virtual environment 502 from physical environment 500. In some examples, in response to detecting movement of a viewpoint of electronic device 101a changing a position and/or orientation relative to virtual environment 502 and/or physical environment 500, electronic device 101a updates the portion of the virtual environment 502 displayed in accordance with the movement. Thus, electronic device 101a can maintain display of virtual environment 502 (e.g., consuming a center, or all of a display of electronic device 101a). In contrast, electronic device 101a can cease display of a portal render of the virtual environment 502 in response to detecting movement of the viewpoint away from the portal render.

In some examples, electronic device 101a and/or electronic device 101b communicate to cause electronic device 101b to display a view of the perspective of electronic device 101a relative to virtual environment 502. For example, electronic device 101a can send information to electronic device 101b, which in response to receiving the information, can display virtual object 514 and/or populate virtual object 514 with the immersion region 512, the displayed portions of virtual environment 502, and/or the visible portions of the physical environment 500. In some examples, the information can be additionally or alternatively communicated to computer system 516, and computer system 516 can display the perspective of electronic device 101a.

In some examples, computer system 516 displays a model of the virtual environment. In some examples, computer system 516 renders virtual environments with a level of visual fidelity that is higher than other renders of virtual environments at less computationally powerful devices (e.g., a headset or a mobile phone). For example, computer system 516 can display a full render with shaders and textures while electronic device 101a displays a simplified or schematic version of a same set of virtual content. Additionally or alternatively, electronic device 101a can display a preview of virtual environment 502 with some of the shaders and/or textures display at computer system 516, but with a lower polygon count, texture resolution, shading accuracy, global illumination, and/or some combination thereof.

In some examples, computer system 516 can host collaborative review sessions in which electronic devices participating in the communication session exchange information placing annotations about their observations and comments about virtual environment 502. In some examples, each device and/or computer system participating in the communication can detect input inserting an annotation into virtual environment 502 and/or into a record of a session during which the users are reviewing virtual environment 502 (e.g., text, a virtual pushpin, a spatial recording of a user moving throughout virtual environment 502, voice input, indications of gaze, the user's attention, and/or pointing of fingers or a cursor, and/or some combination thereof). In response to detecting the input, the detecting device can share the annotation with the other devices in the multi-user communication session. In response to receiving an indication of an annotation from another device, the receiving device can display the annotation overlaying virtual environment 502. At both the sending and receiving devices, the annotation can share a location within virtual environment 502, thus synchronizing the placement of annotations between the devices.

In some examples, one or more of electronic device 101a, electronic device 101b, and/or computer system 516 defines characteristics of an environmental template. For example, computer system 516 can display a user interface for content creation and can display a menu of different project types available. The project types can correspond to a likely intended output of virtual content generated while using the project, such as a spatial video (e.g., a rectilinear three-dimensional video presented via a virtual frame including a simulation of parallax), an immersive video (e.g., video presented immersively consuming 180 or 360 degrees around the viewpoint of the user), a three-dimensional environment project, and/or a conventional two-dimensional video. When establishing the project based upon a selected project type, computer system 516 can automatically assume a particular environmental format, such as those environmental formats described herein. Additionally or alternatively, computer system 516 can prompt a user of computer system 516 for additional characteristics of the format, such as a size of a portal, a position of a portal, a size and/or position of a virtual model, a level of immersion, whether to include a virtual model and/or a portal, a size of a viewing box, dimensions of a virtual stage, a spatial profile of a virtual stage and/or a background for projecting background content, and/or some combination thereof.

In some examples, in accordance with any settings the user specifies and/or any settings left as default values, computer system 516 can send data and/or metadata to other devices in the communication session. In some examples, the recipient devices can approve (or reject) an invitation to receive the data and/or metadata and can display a view of an environment in accordance with the environmental template and/or settings indicated by computer system 516. In some examples, other devices such as electronic device 101a and/or 101b can define some or all of the aforementioned characteristics of the environmental format and can display the virtual environment 502 (or other virtual environments) in accordance with the specified characteristics and/or settings. Displaying three-dimensional representations in an immersive view concurrent with the two-dimensional or simulated two-dimensional view of an environment allows a single device to potentially present concurrent representations of a same virtual scene in different ways, which can reduce the processing required to display the different views of the same views on different devices and can reduce the number of devices used to preview how the different views may be presented on different types of displays (e.g., immersive and conventional two-dimensional displays such as a television). Additionally, the scene may presented in a manner that simulates the experience of being placed in the scene while concurrently providing visibility of the user's physical surroundings, improving the user's awareness of their physical environment while presenting the manner by which another electronic device might present an immersive view of the scene, such as previewing how the scene may look when presented by an XR-capable electronic device.

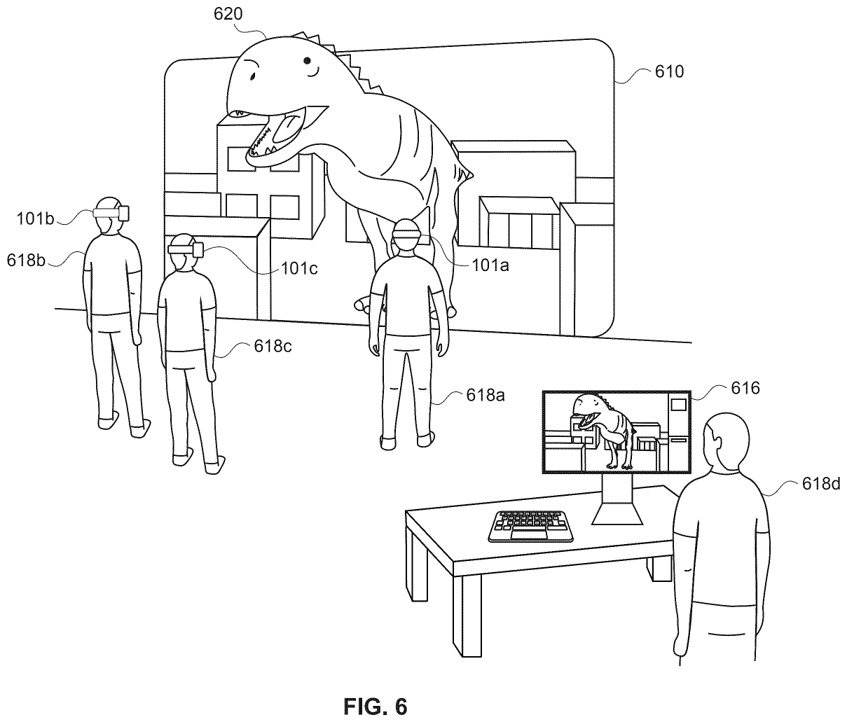

FIG. 6 illustrates display of review of animations according to some examples of the disclosure. In some examples, electronic device 101 displays a portal, using techniques similar to or the same as described with reference to FIG. 4. In FIG. 6, computer system 616 initiates display of an animation of a virtual asset moving relative to a virtual scene in response to detecting input initiating replaying of the animation from user 618d. In some examples, portal 610 can display a view of a virtual three-dimensional environment. As shown in FIG. 6, the environmental format can correspond to a template in which portal 610 is displayed without concurrently displaying a virtual model of a virtual three-dimensional environment.

Users 618a through 618c, respectively participating in a multi-user communication session with computer system 616 via electronic device 101a through 101c, can concurrently present portal 610 via electronic devices 101a through 101c. For example, computer system 616 can stream virtual scene and/or animation data to electronic device 101a through 101c to display the animation. Electronic devices 101a through 101c can display portal 610 with respective orientations based upon the respective viewpoints of electronic devices 101a through 101c relative to a location within the physical environment specified by computer system 616.

In some examples, animated virtual content can move beyond the dimensions of portal 610, such as into regions where the physical environment is presented and/or displayed. For example, virtual object 620, which corresponds to a virtual representation of a dinosaur, is displayed in FIG. 6 extruded away from the surface of portal 610. As described with reference to FIG. 4, a portal, such as portal 610, can be a two-dimensional virtual object. As shown in FIG. 6, virtual object 620 is displayed overlaying portions of the three-dimensional environment of electronic devices 101a through 101c corresponding to the physical environment (e.g., beyond and outside of the surface of portal 610). In some examples, while the communication session is ongoing, computer system 616 can share information newly introducing the animation into the virtual three-dimensional environment. In response to receiving information from computer system 616 during the communication session, electronic devices 101a through 101c can initiate the animation as described above (e.g., moving beyond portal 610). Thus, computer system 616 can cause display of animated virtual content that extends beyond portal 610 which is first created while the collaborative communication session between computer system 616 and electronic devices 101a through 101c is ongoing.

In some examples, while displaying portal 610, electronic devices 101a through 101c and/or computer system 616 can detect targets of attention and share the targets of attention with other participants in the multi-user communication session. By displaying targets of attention, devices can efficiently point toward and/or understand a target of discussion. In some examples, displaying targets of attention are used when indicating a prospective animation of an object moving within the virtual three-dimensional environment.

Electronic device 101a, for example, can detect a user gazing toward locations within portal 610, can detect a user pointing toward locations using their fingers and/or using a pointing device such as a stylus, and/or can detect movement of a joystick controlling a cursor. Electronic device 101a can display a visual indication of the target of attention such as a glowing cursor at the targeted location and can trace a path across the virtual environment in accordance with detected movement of the attention throughout portal 610. Electronic device 101a can share information indicative of the attention with other electronic devices 101b and 101c and/or computer system 616. In response to receiving the information, the devices can respectively display visual indications of the attention targeting and/or moving throughout the virtual environment, mirroring the movement of attention.

In some examples, an electronic device can detect input requesting placement of an annotation into the virtual three-dimensional environment. In response to detecting the input, the electronic device can prompt a user for information corresponding to an annotation and/or a description of virtual object. For example, electronic device 101a can display a user interface prompting the user to provide speech, air gesture(s), text entry (e.g., via a virtual or physical keyboard), movement, attention, and/or other suitable modalities of information. Such a user interface can include one or more virtual buttons to initiate text entry, recordings of voice, recordings of movement, and/or recordings of the user's attention, and/or to cease such text entry and/or recordings. In some examples, the information provided by the user includes a description associated with the virtual object, a name of the virtual object, metadata associated with the virtual objects such as a category of the virtual object, and/or other suitable information that a future inspector of the virtual object might be interested in. After text entry and/or recordings provided by the user are complete, the electronic device can cease display of the user interface and/or associate the provided information with a corresponding virtual object. In some examples, the electronic device begins recording and/or initiates text entry without display of a dedicated user interface in response to insertion of a virtual object and/or in response to detecting input directed toward an animated virtual object. Presenting a virtual scene using portal 610 may allow several devices to synchronize a view of a same set of virtual content and/or without requiring a dedicated external display that occupies the physical environment, thereby improving the likelihood users can collaboratively inspect, edit, and/or export media while and/or after collaborating with a workstation or other computer system such as computer system 616.

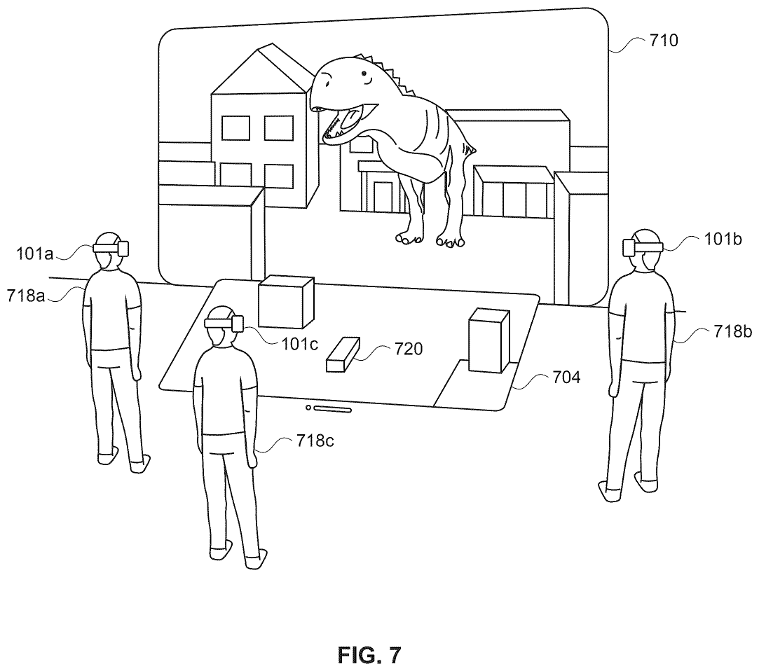

FIG. 7 illustrates an example of electronic devices presenting a virtual three-dimensional environmental template including a virtual model and an environmental preview according to some examples of the disclosure. As described with reference to FIG. 4 and FIG. 6, electronic devices such as electronic devices 101a through 101c can be in a communication session with each other and/or a computer system that streams data to electronic devices 101a through 101c. In some examples, the data can be used to present a virtual three-dimensional environment in accordance with an environmental template. For example, electronic devices 101a through 101c in FIG. 7 can receive an indication that the computer system requests display of the virtual three-dimensional environment in accordance with an environmental format that includes a preview of the virtual three-dimensional environment such as portal 710 and a virtual model 704. It is understood that some or all of the techniques and/or operations described with reference to the templates shown in FIGS. 4 and 6 can apply to the examples described with reference to FIG. 7.

In some examples, the environmental format and/or data from the computer system additionally or alternatively indicates the spatial arrangement of portal 710 and/or virtual model 704, and/or what portion of the virtual environment is presented within the portal 710 and/or virtual model 704. For example, the portal 710 can present a two-dimensional view of a portion of the virtual three-dimensional environment represented in three-dimensions within virtual model 704. Additionally or alternatively, portal 710 and/or virtual model 704 can include different portions of the virtual three-dimensional environment. For example, in FIG. 7, virtual model 704 includes an oblong virtual object 720 that is not displayed and/or presented in portal 710. As shown in FIG. 7, virtual model 704 does not include a visual indication corresponding to portal 710, given that portal 710 corresponds to a portion of the virtual three-dimensional environment different from the portion displayed in virtual model 704.

As shown in FIG. 7, portal 710 and virtual model 704 are displayed at positions within a representation of a physical environment that is the same for each of electronic devices 101a through 101c. Accordingly, portal 710 and virtual model 704 can be world-locked virtual content. In some examples, users 718a through 718c can move portal and virtual model 704 relative to a three-dimensional environment of the users 718a through 718c. For example, electronic devices 101a through 101c can detect input directed to selectable options such as buttons and/or icons, and in response, can move portal 710 and/or virtual model 704 separately or concurrently in accordance with the input. In some examples, when a first electronic device moves portal 710 and/or virtual model 704, the other electronic devices participating in the communication session move portal 710 and/or virtual model 704 to the updated position specified by the input detected by the first electronic device. By concurrently displaying the virtual model 704 and portal 710, electronic devices 101a through 101c may synchronize the spatial data that can dictate where virtual assets are displayed in portal 710 and visualize the spatial data as occupying three dimensions of the three-dimensional environment, thereby presenting the virtual scene in a manner which can be more intuitive and/or may not be possible using conventional two-dimensional displays. Further, editing and/or previewing spatial media via the communication session between electronic devices 101a through 101c as described with reference to FIG. 7 may allow for the concurrent inspection of the spatial relationship of assets in the spatial media using virtual model 704 while also previewing how the view of a simulated camera might capture the assets, as presented in portal 710.

In some examples, the computer system streaming environmental data to electronic device 101a through 101c and/or electronic device 101a through 101c can change between environmental templates. For example, the electronic devices 101a through 101c can detect an input changing the environmental template used to present the virtual three-dimensional environment. The input, for example, can be a voice command, a selection of one or more buttons, icons, affordances, text, and/or representations of an environmental template while displaying a first environmental template (e.g., the template shown in FIG. 7). In response to receiving the input, electronic devices 101a through 101c can present the virtual three-dimensional environment in accordance with the input. For example, electronic device 101a, can initially present the virtual three-dimensional environment while displaying a virtual model only (e.g., model 404 in FIG. 4), and can detect selection of a button from a menu requesting display of a portal and a virtual mode. In response to detecting the input selecting the button, electronic device 101a can cease display of model 404 and/or move model 404 to the position shown in FIG. 7 (e.g., corresponding to virtual model 704), and/or can concurrently display portal 710.

Additionally or alternatively, electronic device 101a can detect input requesting display of a portal-only environmental template and can change the environmental template from as shown in FIG. 7 to as shown in FIG. 6. In some examples, electronic device 101a maintains display of virtual content that is common between the selected types of templates when changing between templates. For example, if the newly selected type of environmental template has a portal (e.g., as shown in FIG. 6), electronic device 101a can maintain display of the portal corresponding to a same portion of the virtual three-dimensional environment when initiating display of an environmental template that includes a virtual model and a portal (e.g., as shown in FIG. 7).

In some examples, electronic device 101a through 101c can change the environmental template used to present the virtual three-dimensional environment in response to detecting input directed toward the virtual three-dimensional environment. For example, electronic device 101a through 101c can detect movement of users 718a through 718c (e.g., a single electronic device can detect movement of a user wearing and/or using the device), such as movement to within a threshold distance of virtual model 704 and/or portal 710. The threshold distance can be 0.05, 0.1, 0.25, 0.5, 0.75, 1, 1.5, 3, 4, or 5m, and can be used to trigger display of an immersive and/or partially immersive display of the virtual three-dimensional environment. For example, electronic device 101a can detect user 718a move to within the threshold distance and/or through portal 710. In response to detecting the movement, electronic device 101a can cease display of virtual model 704 and/or portal 710, and/or can display the virtual three-dimensional environment in accordance with an immersive environmental template. For example, electronic device 101a can animate and/or initiate display of the virtual environment with a particular scale, such as shown in FIG. 5. Additionally or alternatively, portions of the physical environment presented via a display of electronic device 101a can be replaced with portions of the virtual environment. For example, electronic device 101a can display the virtual three-dimensional environment as though the user is standing with a physical equivalent of the virtual three-dimensional environment.

In some examples, the level of immersion is a 5%, 10%, 25%, 50%, 75%, 90%, or 100% level of immersion. As an example, in response to detecting the movement of the user 718a through portal 710, electronic device 101a can display the virtual three-dimensional environment consuming all of the viewport of electronic device 101a. In some examples, the portion of the three-dimensional environment consumed by the virtual three-dimensional environment is mapped to the physical environment. For example, the region where the virtual three-dimensional environment is displayed immersively can be fixed and mapped to portions of the physical three-dimensional environment. Accordingly, in response to detecting movement of the viewpoint of electronic device 101a away from the region where the virtual three-dimensional environment is displayed, electronic device 101a can present portions of the physical three-dimensional environment, akin to if the virtual three-dimensional environment at least temporarily occupied a portion of the physical three-dimensional environment, but not all of the physical three-dimensional environment. In the example in which the three-dimensional environment is displayed with a full level of immersion (e.g., 100%), electronic device 101a can forgo presenting of the physical environment, because all of the physical environment is virtually occupied by the virtual three-dimensional environment.

It is understood that in accordance with various inputs, electronic devices 101a through 101c can change between the environmental templates described with reference to FIGS. 3-8. The description of various operations below, for example, optionally applies to one, some, or all of the examples described with reference to FIGS. 3-8. For example, while displaying a virtual three-dimensional environment immersively, electronic device 101a can detect input requesting incorporation of a virtual stage as described with reference to FIG. 3. In response to detecting the input, electronic device 101a can display the virtual stage 306 and/or can change the level of immersion to display physical portions of the three-dimensional environment 334 and/or 336.

Additionally or alternatively, the computer system can detect one or more inputs loading a new workflow and/or project to share with electronic devices 101a through 101c. The new project, for example, can be associated with a particular environmental format and/or a type of targeted type of data to export, such as a spatial video, immersive video, environmental, and/or a two-dimensional content creation project. The computer system can send electronic devices 101a through 101c an indication that the new project should be loaded and/or a new virtual three-dimensional environment should be displayed. In some examples, the computer system additionally or alternatively sends an indication that a particular environmental format corresponds to the new project and/or new virtual three-dimensional environment. In response to receiving the indication(s) from the computer system, electronic device 101a through 101c can cease display of a currently displayed virtual three-dimensional environment, and initiate display of a new virtual three-dimensional environment using an environmental template that matches the requested environmental format and/or template.

In some examples, displaying the virtual scene using an environmental format includes displaying a viewbox corresponding to a region within the virtual scene. By presenting a same virtual scene in accordance with various environmental templates, the presenting device can ensure that virtual content is presented in a manner conducive to inspection, editing, and/or exporting of assets, such as presenting an appropriate scale and/or view of the virtual scene.

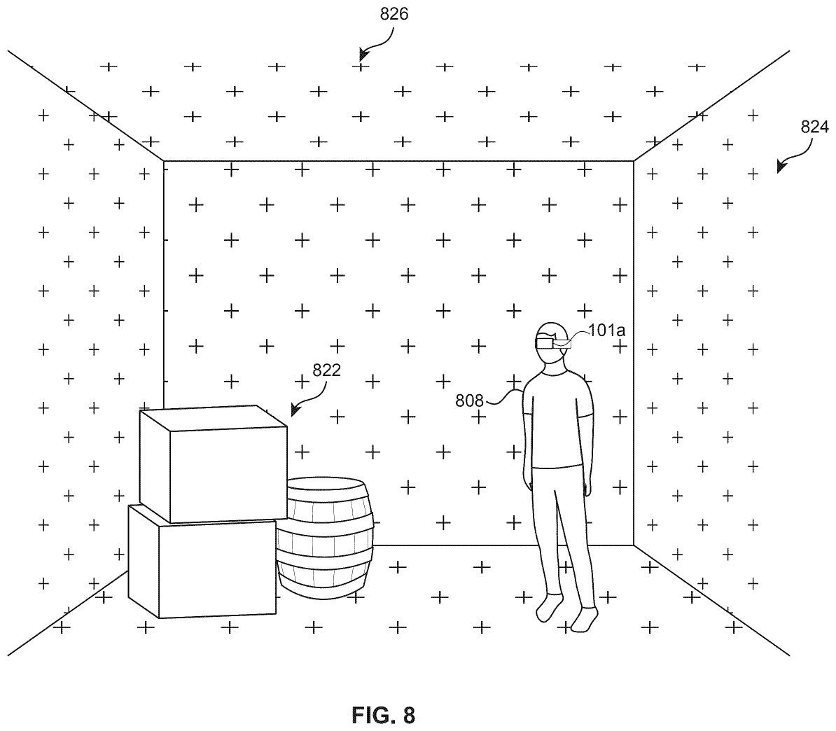

FIG. 8 illustrates an example of an electronic device presenting a virtual three-dimensional environmental template including a viewbox according to some examples of the disclosure. A viewbox 824, as referred to herein, can be a virtual volume that can restrict which portion(s) of a virtual three-dimensional environment are presented to the user to draw user focus toward aspects of the virtual three-dimensional environment. In the context of a media production workflow, the viewbox can limit the amount of visual stimulus presented to the user, improving the likelihood that a user can focus on a subset of the virtual three-dimensional environment such as a group of virtual objects and/or less than all of the virtual three-dimensional environment. Thus, a viewbox environmental template can be useful for when a user is interested in exporting virtual objects, virtual textures, virtual lighting effects, and/or portions of a virtual three-dimensional environment, especially when iterating through rough ideations and/or refining a design for such virtual content.

In some examples, the viewbox 824 includes a plurality of markers 826 that indicate a scale of the virtual three-dimensional environment. Markers 826 can assist user 808 when inspecting virtual content such as the virtual objects 822. Virtual objects 822 include virtual boxes and a virtual barrel, which can be included in the virtual three-dimensional environment at a location bound by the viewbox 824.

In some examples, viewbox 824 occupies virtual space corresponding to a physical region (e.g., in a manner similar to the virtual stage described above). In some examples, viewbox 824 corresponds to a volume within a virtual three-dimensional environment, and virtual assets bound within the volume are at least partially displayed within viewbox 824. In some examples, displaying a virtual environment using viewbox 824 includes forgoing display of some or all of the virtual three-dimensional environment. For example, one or more of the walls, ceiling, and/or floor of viewbox 824 may not include virtual content from the virtual three-dimensional environment. In some examples, some or all of the walls, ceiling, and/or floor of viewbox 824 include a two-dimensional image of the virtual three-dimensional environment. In some examples, some or all of the walls, ceiling, and/or floor of the viewbox 824 are rendered using techniques similar to, or the same as described with reference to the virtual stage above.

In some examples, electronic device 101a can detect inputs changing a scale of viewbox 824 and can scale virtual content such as virtual objects 822 and/or markers 826 in accordance with the input. In this way, electronic device 101a can make virtual content from the virtual three-dimensional environment bigger or smaller in accordance with the user's preference. In some examples, viewbox 824 can be of a different scale, dimension, shape, and/or some combination thereof. For example, the length, width, and/or height of viewbox 824 can be defined and/or modified by the computer system that streams data to electronic device 101a to display the viewbox 824. Additionally or alternatively, an environmental template can include a spherical, rounded, other rectilinear, and/or a hybrid shaped viewbox including different lines, curves, and/or surfaces of varying spatial profiles and/or dimensions.

In one or more of the examples described herein, electronic device 101a can change or maintain a perspective relative to the virtual three-dimensional environment in accordance with a currently implemented environmental template. For example, in response to detecting movement of a viewpoint of electronic device 101a relative to a virtual environment displayed in an immersive environmental template, electronic device 101a can update the displayed virtual content in accordance with movement of the viewpoint, similar to the manner by which the user can physically see their physical surrounding change in accordance with movement relative to a physical environment. Thus, in response to detecting a change in viewpoint relative to an at least partially immersive virtual three-dimensional environment, electronic device 101a can cease display of virtual content and/or initiate display of virtual content included in the virtual three-dimensional environment.

In some examples, in response to detecting a change in viewpoint of electronic device 101a, electronic device 101a can maintain display of a perspective relative to virtual three-dimensional environment. For example, when displaying a viewing portal, electronic device 101a can forgo changing which portions of the three-dimensional environment are presented in the viewing portal in response to detecting changes in the viewpoint of electronic device 101a. In this way, a user of electronic device 101a can be consistently presented with a perspective into the virtual three-dimensional environment that is fixed in accordance with how the portal is positioned and/or oriented relative to the virtual three-dimensional environment.

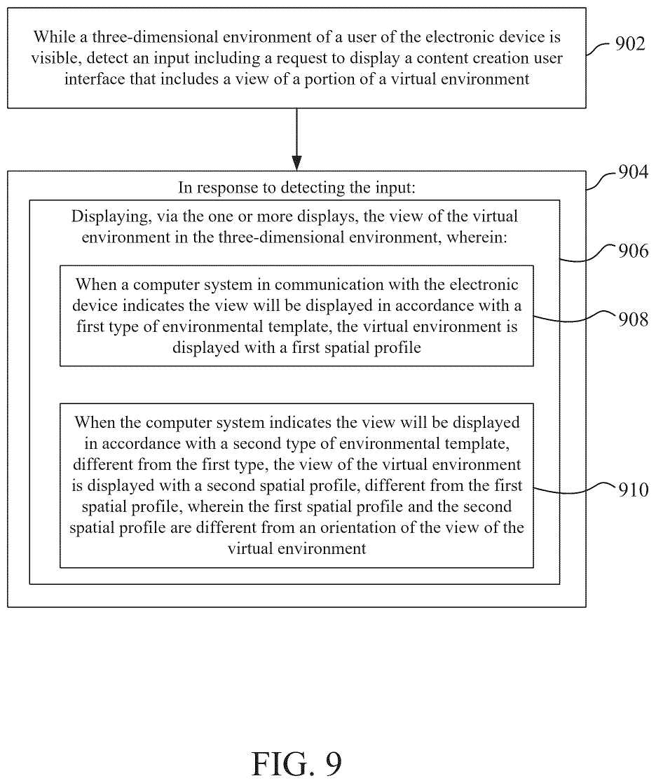

FIG. 9 is a flow chart of a method of presenting a virtual three-dimensional environment in accordance with a template according to some examples of the disclosure.

In some examples, instructions for executing method 900 are stored using a (e.g., non-transitory) computer readable storage medium, and executing the instructions causes an electronic device (e.g., electronic device 101 or electronic device 201) to perform method 900.

At 902, in some examples, method 900 comprises, while a three-dimensional environment of a user of an electronic device is visible, the electronic device detects an input including a request to display a content creation user interface that includes a view of a portion of a virtual environment, such as user interface including some or all of the virtual content shown in three-dimensional environment 302. At 904, in some examples, method 900 comprises in response to detecting the input, displaying, at 906, via the one or more displays, the view of the virtual environment in the three-dimensional environment, such as the display of virtual model 404 and/or portal 410 as shown in FIG. 4, the display of immersion region 512 as shown in FIG. 5, and/or the display of the viewbox 824 as shown in FIG. 8. At 908, in some examples, when a computer system in communication with the electronic device indicates the view will be displayed in accordance with a first type of environmental template, the virtual environment is displayed with a first spatial profile, such as a spatial profile of virtual stage 306 and/or background 304 as shown in FIG. 3. At 910, in some examples, when the computer system indicates the view will be displayed in accordance with a second type of environmental template, different from the first type, the view of the virtual environment is displayed with a second spatial profile, different from the first spatial profile, wherein the first spatial profile and the second spatial profile are different from an orientation of the view of the virtual environment, such as display of portal 710 and/or virtual model 704 as shown in FIG. 7.

Additionally or alternatively, in some examples, the first spatial profile includes a first shape of the view relative to the three-dimensional environment, and the second spatial profile includes a second shape, different from the first shape, of the view relative to the three-dimensional environment. Additionally or alternatively, in some examples, the first shape corresponds to a two-dimensional shape, and the second shape corresponds to a three-dimensional shape. Additionally or alternatively, in some examples, the view when displayed with the first spatial profile occupies a first portion of a viewport of the one or more displays, and the view when displayed with the second spatial profile occupies a second portion of the viewport, different from the first portion. Additionally or alternatively, in some examples, the first portion of the viewport includes less than a field of view of the viewport. Additionally or alternatively, in some examples, the first portion of the viewport entirely consumes a field of view of the viewport. Additionally or alternatively, in some examples, the user has a viewpoint relative to the three-dimensional environment that is a first viewpoint when the input is detected and when displaying the view of the virtual environment, the method 900 further comprises: while the viewpoint is the first viewpoint, detecting, via the one or more input devices, a request to change the viewpoint to be a second viewpoint, different from the first viewpoint; and in response to detecting the request, updating the view of the virtual environment in accordance with the change in the viewpoint. Additionally or alternatively, in some examples, when the viewpoint of the user is the first viewpoint, a portion of a viewport of the electronic device is occupied by the virtual environment, and the portion of the viewport of the electronic device remains occupied by the virtual environment when the viewpoint of the user is the second viewpoint. Additionally or alternatively, in some examples, a first portion of a viewport of the electronic device is occupied by the virtual environment when the viewpoint of the user is the first viewpoint, and a second portion of the viewport, different from the first portion, is occupied by the virtual environment when the viewpoint of the user is the second viewpoint. Additionally or alternatively, in some examples, the first spatial profile corresponds to a world-locked viewing volume. Additionally or alternatively, in some examples, the input includes selection of a selectable option, the method 900 further comprises: while presenting the three-dimensional environment, receiving an indication that three-dimensional graphics data representing the virtual environment is available to the electronic device from the computer system; and in response to receiving the indication, displaying one or more selectable options that are respectively selectable to select the view of the virtual environment. Additionally or alternatively, in some examples, the three-dimensional graphics data includes one or more of: one or more images or data corresponding to a virtual objects. Additionally or alternatively, in some examples, method 900 further comprises: while presenting the three-dimensional environment and displaying the view of the virtual environment, receiving an indication of changes to the three-dimensional graphics data from the computer system; and in response to detecting the indication, updating the view of the virtual environment in accordance with the changes to the three-dimensional graphics data. Additionally or alternatively, in some examples, method 900 further comprises: in response to detecting the input, and when the view corresponds to the first type of environmental template, displaying, via the display, a virtual object corresponding to a representation of at least the portion of the virtual environment, wherein the virtual object is different from, and concurrently displayed with, the view of the virtual environment. Additionally or alternatively, in some examples, method 900 further comprises: while displaying the view of the virtual environment, receiving one or more inputs requesting export of content corresponding to the virtual environment; in response to receiving the one or more inputs: in accordance with a determination that the view corresponds to the first type of environmental template, exporting one or more first types of virtual content; and in accordance with a determination that the view corresponds to the second type of environmental template, exporting one or more second types of virtual content. Additionally or alternatively, in some examples, the one or more first types of virtual content include one or more of: virtual objects, images, video, scenic data, animation data, and virtual cameras. Additionally or alternatively, in some examples, the method 900 further comprises: in response to detecting the input, joining a multi-user communication session between the computer system that provides three-dimensional graphics data used to display the view of the virtual environment and a respective computer system, different from the computer system, wherein: one or more characteristics of the electronic device are the same as one or more characteristics of the respective computer system, and the respective computer system displays a respective view of the portion of the virtual environment based upon a viewpoint of a user of the respective computer system relative to the three-dimensional environment while the real-time communication session is ongoing.

Additionally or alternatively, in some examples, method 900 further comprises: while the three-dimensional environment is visible and while displaying the view of the virtual environment with the first spatial profile, receiving a respective input including a request to change the view of the portion of the virtual environment; and in response to receiving the respective input, changing the view of the virtual environment from being displayed with the first spatial profile to being displayed with the second spatial profile. Additionally or alternatively, in some examples, when displaying the virtual environment with the first spatial profile that includes a first shape relative to the three-dimensional environment, first virtual content associated with the virtual environment is displayed extending beyond dimensions of the first shape. Additionally or alternatively, in some examples, the first type of environmental template corresponds to one or more of a viewing portal template, a virtual stage template, a viewbox template, a virtual model template, and an immersive template.

Some examples of the disclosure are directed to an electronic device including memory and one or more processors coupled to the memory and configured to perform the method 900. Some examples of the disclosure are directed to a non-transitory computer readable storage medium storing instructions that, when executed by an electronic device including memory and one or more processors coupled to the memory, causes the electronic device to perform the method 900.

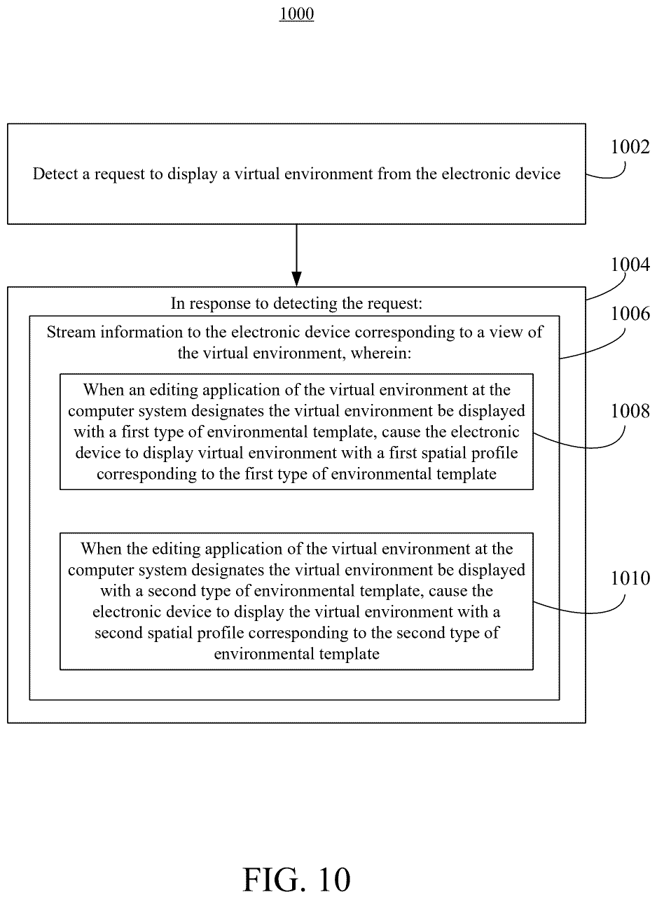

FIG. 10 is a flow chart of a method of streaming information from a computer system to an electronic device to cause the electronic device to present a virtual three-dimensional environment in accordance with a template according to some examples of the disclosure.

In some examples, instructions for executing method 1000 are stored using a (e.g., non-transitory) computer readable storage medium, and executing the instructions causes an electronic device (e.g., electronic device 101 or electronic device 201) to perform method 1000.

At 1002, in some examples, method 1000 comprises, at computer system in communication with an electronic device, one or more input devices and one or more displays: detecting a request to display a virtual environment from the electronic device. At 1004, in some examples, in response to detecting the input: the computer system streams information to the electronic device corresponding to a view of the virtual environment at 1006. In some examples, when an editing application of the virtual environment at the computer system designates the virtual environment be displayed with a first type of environmental template, the computer system causes the electronic device to display virtual environment with a first spatial profile corresponding to the first type of environmental template at 1008. In some examples, when the editing application of the virtual environment at the computer system designates the virtual environment be displayed with a second type of environmental template, the computer system causes the electronic device to display the virtual environment with a second spatial profile corresponding to the second type of environmental template at 1010. Some examples of the disclosure are directed to a computer system including memory and one or more processors coupled to the memory and configured to perform the method 1000. Some examples of the disclosure are directed to a non-transitory computer readable storage medium storing instructions that, when executed by a computer system including memory and one or more processors coupled to the memory, causes the computer system to perform the method 1000.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

Additionally or alternatively, in some examples, the first spatial profile includes a first shape of the view relative to a three-dimensional environment, and the second spatial profile includes a second shape, different from the first shape, of the view relative to the three-dimensional environment. Additionally or alternatively, in some examples, the first spatial profile corresponds to a world-locked viewing volume. Additionally or alternatively, in some examples, while presenting a three-dimensional environment, the method can further comprise transmitting an indication that three-dimensional graphics data representing the virtual environment is available to the electronic device from the computer system, and causing the electronic device to display one or more selectable options that are respectively selectable to select the view of the virtual environment. Additionally or alternatively, in some examples, while the electronic device is displaying the view of the virtual environment, the method can further comprise in accordance with a determination that the view corresponds to the first type of environmental template, receiving one or more first types of virtual content exported from the electronic device, in accordance with a determination that the view corresponds to the second type of environmental template, receiving one or more second types of virtual content exported from the electronic device. Additionally or alternatively, in some examples, the method can further comprise, joining a multi-user communication session between the computer system that provides three-dimensional graphics data used to display the view of the virtual environment and a respective computer system, different from the computer system, wherein one or more characteristics of the electronic device are the same as one or more characteristics of the respective computer system, and the respective computer system displays a respective view of the portion of the virtual environment based upon a viewpoint of a user of the respective computer system relative to a three-dimensional environment while the multi-user communication session is ongoing. In some examples, the method can further comprise, while a three-dimensional environment is visible and while displaying the view of the virtual environment with the first spatial profile, receiving a respective input including a request to change the view of the portion of the virtual environment, and in response to receiving the respective input, changing the view of the virtual environment from being displayed with the first spatial profile to being displayed with the second spatial profile. Additionally or alternatively, in some examples, the first type of environmental template corresponds to one or more of a viewing portal template, a virtual stage template, a viewbox template, a virtual model template, and an immersive template.

Some examples of the disclosure are directed to a computer system comprising, one or more processors, memory, and one or more programs, wherein the one or more programs are stored in the memory and configured to be executed by the one or more processors, the one or more programs including instructions for, detecting a request to display a virtual environment from an electronic device in communication with the computer system, in response to detecting the request, streaming information to the electronic device corresponding to a view of the virtual environment, wherein, when an editing application of the virtual environment at the computer system designates the virtual environment be displayed with a first type of environmental template, causing the electronic device to display virtual environment with a first spatial profile corresponding to the first type of environmental template, when the editing application of the virtual environment at the computer system designates the virtual environment be displayed with a second type of environmental template, causing the electronic device to display the virtual environment with a second spatial profile corresponding to the second type of environmental template. It is understood that the one or more programs including instructions for one or more operations may include examples in which the one or more programs include instructions which when executed by one or more processors of the computer system may cause the computer system to perform the corresponding one or more operations.

Additionally or alternatively, in some examples, the first spatial profile includes a first shape of the view relative to the three-dimensional environment, and the second spatial profile includes a second shape, different from the first shape, of the view relative to the three-dimensional environment. Additionally or alternatively, in some examples, the one or more instructions are further for, while presenting the three-dimensional environment, transmitting an indication that three-dimensional graphics data representing the virtual environment is available to the electronic device from the computer system, and causing the electronic device to display one or more selectable options that are respectively selectable to select the view of the virtual environment. Additionally or alternatively, in some examples, the one or more instructions are further for, while the electronic device is displaying the view of the virtual environment, in accordance with a determination that the view corresponds to the first type of environmental template, receiving one or more first types of virtual content exported from the electronic device, and in accordance with a determination that the view corresponds to the second type of environmental template, receiving one or more second types of virtual content exported from the electronic device. Additionally or alternatively, in some examples, the one or more instructions are further for, joining a multi-user communication session between the computer system that provides three-dimensional graphics data used to display the view of the virtual environment and a respective computer system, different from the computer system, wherein, one or more characteristics of the electronic device are the same as one or more characteristics of the respective computer system, and the respective computer system displays a respective view of the portion of the virtual environment based upon a viewpoint of a user of the respective computer system relative to the three-dimensional environment while the multi-user communication session is ongoing. Additionally or alternatively, in some examples, the one or more instructions are further for, while the three-dimensional environment is visible and while displaying the view of the virtual environment with the first spatial profile, receiving a respective input including a request to change the view of the portion of the virtual environment, and in response to receiving the respective input, changing the view of the virtual environment from being displayed with the first spatial profile to being displayed with the second spatial profile. Additionally or alternatively, in some examples, first type of environmental template corresponds to one or more of a viewing portal template, a virtual stage template, a viewbox template, a virtual model template, and an immersive template.

Some examples of the disclosure are directed to a non-transitory computer readable storage medium storing instructions that, which when executed by one or more processors of a computer system that is in communication with a display generation component and one or more input devices, cause the computer system to, detect a request to display a virtual environment from an electronic device in communication with the computer system, and in response to detecting the request, stream information to the electronic device correspond to a view of the virtual environment, wherein, when an editing application of the virtual environment at the computer system designates the virtual environment be displayed with a first type of environmental template, cause the electronic device to display virtual environment with a first spatial profile corresponding to the first type of environmental template, and when the editing application of the virtual environment at the computer system designates the virtual environment be displayed with a second type of environmental template, cause the electronic device to display the virtual environment with a second spatial profile corresponding to the second type of environmental template.

Additionally or alternatively, in some examples, the first spatial profile includes a first shape of the view relative to a three-dimensional environment, and the second spatial profile includes a second shape, different from the first shape, of the view relative to the three-dimensional environment. Additionally or alternatively, in some examples, the instructions when executed further cause the computer system to, while presenting a three-dimensional environment, transmit an indication that three-dimensional graphics data representing the virtual environment is available to the electronic device from the computer system, cause the electronic device to display one or more selectable options that are respectively selectable to select the view of the virtual environment. Additionally or alternatively, in some examples, the instructions when executed further cause the computer system to, while the electronic device is displaying the view of the virtual environment, in accordance with a determination that the view corresponds to the first type of environmental template, receiving one or more first types of virtual content exported from the electronic device, and in accordance with a determination that the view corresponds to the second type of environmental template, receiving one or more second types of virtual content exported from the electronic device. Additionally or alternatively, in some examples, the instructions when executed further cause the computer system to, join a multi-user communication session between the computer system that provides three-dimensional graphics data used to display the view of the virtual environment and a respective computer system, different from the computer system, wherein, one or more characteristics of the electronic device are the same as one or more characteristics of the respective computer system, and the respective computer system displays a respective view of the portion of the virtual environment based upon a viewpoint of a user of the respective computer system relative to a three-dimensional environment while the multi-user communication session is ongoing.

The present disclosure contemplates that in some examples, the data utilized can include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information. Specifically, as described herein, one aspect of the present disclosure is tracking a user's biometric data.

The present disclosure recognizes that the use of such personal information data, in the present technology, can be used to the benefit of users. For example, personal information data can be used to display suggested text that changes based on changes in a user's biometric data. For example, the suggested text is updated based on changes to the user's age, height, weight, and/or health history.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user can be notified upon initiating collection that their personal information data will be accessed and then reminded again just before personal information data is accessed by the one or more devices.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

The foregoing description, for purpose of explanation, has been described with reference to specific examples. However, the illustrative descriptions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at an electronic device in communication with one or more input devices and one or more displays:
while a three-dimensional environment of a user of the electronic device is visible, detecting an input including a request to display a content creation user interface that includes a view of a portion of a virtual environment;
in response to detecting the input:
displaying, via the one or more displays, the view of the virtual environment in the three-dimensional environment, wherein:
when a computer system in communication with the electronic device indicates the view corresponds to a first type of environmental template, the virtual environment is displayed with a first spatial profile; and
when the computer system indicates the view corresponds to a second type of environmental template, different from the first type, the view of the virtual environment is displayed with a second spatial profile, different from the first spatial profile, wherein the first spatial profile and the second spatial profile are different from an orientation of the view of the virtual environment.

2. The method of claim 1, wherein the user has a viewpoint relative to the three-dimensional environment that is a first viewpoint when the input is detected and when displaying the view of the virtual environment, the method further comprising:
while the viewpoint is the first viewpoint, detecting, via the one or more input devices, a request to change the viewpoint to be a second viewpoint, different from the first viewpoint; and
in response to detecting the request, updating the view of the virtual environment in accordance with the change in the viewpoint.

3. The method of claim 1, wherein the first spatial profile corresponds to a world-locked viewing volume.

4. The method of claim 1, further comprising:
while presenting the three-dimensional environment and displaying the view of the virtual environment, receiving an indication of changes to three-dimensional graphics data that corresponds to the virtual environment from the computer system; and
in response to detecting the indication, updating the view of the virtual environment in accordance with the changes to the three-dimensional graphics data.

5. The method of claim 1, further comprising:
in response to detecting the input, and when the view corresponds to the first type of environmental template, displaying, via the display, a virtual object corresponding to a representation of at least the portion of the virtual environment, wherein the virtual object is different from, and concurrently displayed with, the view of the virtual environment.

6. The method of claim 1, further comprising:
while displaying the view of the virtual environment, receiving one or more inputs requesting export of content corresponding to the virtual environment;
in response to receiving the one or more inputs:
in accordance with a determination that the view corresponds to the first type of environmental template, exporting one or more first types of virtual content; and
in accordance with a determination that the view corresponds to the second type of environmental template, exporting one or more second types of virtual content.

7. The method of claim 1, further comprising:
in response to detecting the input, joining a multi-user communication session between the computer system that provides three-dimensional graphics data used to display the view of the virtual environment and a respective computer system, different from the computer system, wherein:
one or more characteristics of the electronic device are the same as one or more characteristics of the respective computer system, and
the respective computer system displays a respective view of the portion of the virtual environment based upon a viewpoint of a user of the respective computer system relative to the three-dimensional environment while the multi-user communication session is ongoing.

8. The method of claim 1, wherein the first type of environmental template corresponds to one or more of a viewing portal template, a virtual stage template, a viewbox template, a virtual model template, and an immersive template.

9. An electronic device in communication with one or more input devices and one or more display, the electronic device comprising:
one or more processors;
memory; and
one or more programs, wherein the one or more programs are stored in the memory and configured to be executed by the one or more processors, the one or more programs including instructions for:
while a three-dimensional environment of a user of the electronic device is visible, detecting an input including a request to display a content creation user interface that includes a view of a portion of a virtual environment;
in response to detecting the input:
displaying, via the one or more displays, the view of the virtual environment in the three-dimensional environment, wherein:
when a computer system in communication with the electronic device indicates the view corresponds to a first type of environmental template, the virtual environment is displayed with a first spatial profile; and
when the computer system indicates the view corresponds to a second type of environmental template, different from the first type, the view of the virtual environment is displayed with a second spatial profile, different from the first spatial profile, wherein the first spatial profile and the second spatial profile are different from an orientation of the view of the virtual environment.

10. The computer system of claim 9, wherein the user has a viewpoint relative to the three-dimensional environment that is a first viewpoint when the input is detected and when displaying the view of the virtual environment, the one or more programs further including instructions for:
while the viewpoint is the first viewpoint, detecting, via the one or more input devices, a request to change the viewpoint to be a second viewpoint, different from the first viewpoint; and
in response to detecting the request, updating the view of the virtual environment in accordance with the change in the viewpoint.

11. The computer system of claim 9, the one or more programs further including instructions for:
while presenting the three-dimensional environment and displaying the view of the virtual environment, receiving an indication of changes to three-dimensional graphics data that corresponds to the virtual environment from the computer system; and
in response to detecting the indication, updating the view of the virtual environment in accordance with the changes to the three-dimensional graphics data.

12. The computer system of claim 9, the one or more programs further including instructions for:
while displaying the view of the virtual environment, receiving one or more inputs requesting export of content corresponding to the virtual environment;
in response to receiving the one or more inputs:
in accordance with a determination that the view corresponds to the first type of environmental template, exporting one or more first types of virtual content; and
in accordance with a determination that the view corresponds to the second type of environmental template, exporting one or more second types of virtual content.

13. The computer system of claim 9, the one or more programs further including instructions for:
in response to detecting the input, joining a multi-user communication session between the computer system that provides three-dimensional graphics data used to display the view of the virtual environment and a respective computer system, different from the computer system, wherein:
one or more characteristics of the electronic device are the same as one or more characteristics of the respective computer system, and
the respective computer system displays a respective view of the portion of the virtual environment based upon a viewpoint of a user of the respective computer system relative to the three-dimensional environment while the multi-user communication session is ongoing.

14. The computer system of claim 9, wherein the first type of environmental template corresponds to one or more of a viewing portal template, a virtual stage template, a viewbox template, a virtual model template, and an immersive template.

15. A non-transitory computer readable storage medium storing instructions that, when executed by one or more processors of an electronic device that is in communication with a one or more displays and one or more input devices, cause the electronic device to:
while a three-dimensional environment of a user of the electronic device is visible, detect an input including a request to display a content creation user interface that includes a view of a portion of a virtual environment;
in response to detecting the input:
display, via the one or more displays, the view of the virtual environment in the three-dimensional environment, wherein:
when a computer system in communication with the electronic device indicates the view corresponds to a first type of environmental template, the virtual environment is displayed with a first spatial profile; and
when the computer system indicates the view corresponds to a second type of environmental template, different from the first type, the view of the virtual environment is displayed with a second spatial profile, different from the first spatial profile, wherein the first spatial profile and the second spatial profile are different from an orientation of the view of the virtual environment.

16. The non-transitory computer readable storage medium of claim 15, wherein the user has a viewpoint relative to the three-dimensional environment that is a first viewpoint when the input is detected and when displaying the view of the virtual environment, wherein the instructions when executed further cause the electronic device to:
while the viewpoint is the first viewpoint, detect, via the one or more input devices, a request to change the viewpoint to be a second viewpoint, different from the first viewpoint; and
in response to detecting the request, update the view of the virtual environment in accordance with the change in the viewpoint.

17. The non-transitory computer readable storage medium of claim 15, wherein the instructions when executed further cause the electronic device to:
while presenting the three-dimensional environment and displaying the view of the virtual environment, receive an indication of changes to three-dimensional graphics data that corresponds to the virtual environment from the computer system; and
in response to detecting the indication, update the view of the virtual environment in accordance with the changes to the three-dimensional graphics data.

18. The non-transitory computer readable storage medium of claim 15, wherein the instructions when executed further cause the electronic device to:
while displaying the view of the virtual environment, receive one or more inputs requesting export of content corresponding to the virtual environment;
in response to receiving the one or more inputs:
in accordance with a determination that the view corresponds to the first type of environmental template, export one or more first types of virtual content; and
in accordance with a determination that the view corresponds to the second type of environmental template, export one or more second types of virtual content.

19. The non-transitory computer readable storage medium of claim 15, wherein the instructions when executed further cause the electronic device to:
in response to detecting the input, join a multi-user communication session between the computer system that provides three-dimensional graphics data used to display the view of the virtual environment and a respective computer system, different from the computer system, wherein:
one or more characteristics of the electronic device are the same as one or more characteristics of the respective computer system, and
the respective computer system displays a respective view of the portion of the virtual environment based upon a viewpoint of a user of the respective computer system relative to the three-dimensional environment while the multi-user communication session is ongoing.

20. The non-transitory computer readable storage medium of claim 15, wherein the first type of environmental template corresponds to one or more of a viewing portal template, a virtual stage template, a viewbox template, a virtual model template.
